(19) United States
(12) Patent Application Publication
(10) Pub. No.: US 2025/0091270 A1
(43) Pub. Date: Mar. 20, 2025

(54) ARRANGEMENT MECHANISM, ROBOT, AND INJECTION MOLDING MACHINE

(71) Applicant: SEIKO EPSON CORPORATION, Tokyo (JP)

(72) Inventors: Seijun HORIE, MATSUMOTO-SHI (JP); Kazunobu MARUYAMA, SHIOJIRI-SHI (JP)

(21) Appl. No.: 18/883,339

(22) Filed: Sep. 12, 2024

(30) Foreign Application Priority Data
Sep. 15, 2023 (JP) 2023-149970

(51) Int. Cl. B29C 45/42

(52) U.S. Cl. CPC B29C 45/42

(57) ABSTRACT

An arrangement mechanism that changes an arrangement of three or more molded products includes a first base on which two or more first molded products product of the three or more molded products are placed, a second base on which one or more second molded products of the three or more molded products are placed, and a first base movement unit changing a relative position of the first base to the second base between a first position and a second position. The first base is associated with a virtual first straight line and the second base is associated with a second straight line. When the relative position is the first position, the first straight line and the second straight line do not overlap, and when the relative position is the second position, the first straight line and the second straight line overlap.

The present application is based on, and claims priority from JP Application Serial Number 2023-149970, filed Sep. 15, 2023, the disclosure of which is hereby incorporated by reference herein in its entirety.

### BACKGROUND

### 1. Technical Field

The present disclosure relates to an arrangement mechanism, a robot, and an injection molding machine.

### 2. Related Art

Research and development have been conducted on a technique of arranging a plurality of molded products molded by an injection molding machine using a molding material containing metal powder in desired positions.

In this regard, an arrangement mechanism configured to change intervals between a plurality of placed molded products is known (see JP-A-2006-017575).

JP-A-2006-017575 is an example of the related art.

The arrangement mechanism as described in JP-A-2006-017575 has a complicated and large-scale structure with many movable components. This caused an increase in manufacturing cost of the arrangement mechanism and is not preferable.

### SUMMARY

According to an aspect of the present disclosure, an arrangement mechanism that changes an arrangement of three or more molded products includes a first base on which two or more first molded products including an 11th molded product and a 12th molded product of the three or more molded products are placed, a second base on which one or more second molded products including a 21st molded product of the three or more molded products are placed, and a first base movement unit changing a relative position of the first base to the second base between a first position and a second position, wherein the 11th molded product and the 12th molded product placed on the first base are located on a virtual first straight line predetermined for the first base, the 21 st molded product placed on the second base is located on a second straight line as a virtual straight line predetermined for the second base and being parallel to the first straight line, when the relative position is the first position, the first straight line and the second straight line do not overlap, and when the relative position is the second position, the first straight line and the second straight line overlap.

According to an aspect of the present disclosure, a robot that transports three or more molded products includes a first end effector holding two or more first molded products including an 11th molded product and a 12th molded product of the three or more molded products, a second end effector holding one or more second molded products including a 21st molded product of the three or more molded products, and an end effector movement unit changing a relative position of the first end effector to the second end effector between a first position and a second position, wherein the 11th molded product and the 12th molded product held by the first end effector are located on a virtual first straight line predetermined for the first end effector, the 21st molded product held by the second end effector is located on a second straight line as a virtual straight line predetermined for the second effector and being parallel to the first straight line, when the relative position is the first position, the first straight line and the second straight line do not overlap, and when the relative position is the second position, the first straight line and the second straight line overlap.

According to an aspect of the present disclosure, an injection molding machine includes the above described arrangement mechanism, an injection molding mechanism molding the three or more molded products by injection molding, and a robot placing the two or more of the first molded products of the three or more molded products molded by the injection molding mechanism on the first base, and placing the one or more of the second molded products of the three or more molded products molded by the injection molding mechanism on the second base.

### BRIEF DESCRIPTION OF THE DRAWINGS

FIG. 1 is a perspective view showing an example of a configuration of an injection molding machine.

FIG. 2 is a top view of the injection molding machine shown in FIG. 1.

FIG. 3 is a top view showing an example of a configuration of an arrangement mechanism.

FIG. 4 is a side view of the arrangement mechanism as seen in a direction indicated by an arrow shown in FIG. 3.

FIG. 5 shows an example of a configuration of a surface facing a cavity among surfaces of a core.

FIG. 6 shows an arrangement of eight molded products placed on the arrangement mechanism shown in FIG. 3.

FIG. 7 shows an arrangement after the arrangement of the eight molded products shown in FIG. 6 is changed as a first base moves closer to a second base by a first base movement distance.

FIG. 8 is a top view showing an example of a state after a relative position of the first base to the second base is changed to a second position in the arrangement mechanism shown in FIG. 3.

FIG. 9 is a side view of the arrangement mechanism as seen in a direction indicated by an arrow shown in FIG. 8.

FIG. 10 shows an example of a pallet in which a plurality of linear grooves for placement of molded products are formed.

FIG. 11 shows an example of a state in which a molded product in a certain groove among the plurality of linear grooves formed in the pallet shown in FIG. 10 is placed.

FIG. 12 shows an example of an arrangement of six molded products placed on the arrangement mechanism when the relative position of the first base to the second base is a first position.

FIG. 13 shows an arrangement after the arrangement of the six molded products illustrated in FIG. 12 is changed when the first base moves closer to the second base by a second base movement distance.

FIG. 14 shows an example of an arrangement of three molded products placed on the arrangement mechanism when the relative position of the first base to the second base is the first position.

FIG. 15 shows an arrangement after the arrangement of the three molded products shown in FIG. 14 is changed when the first base moves closer to the second base by a third base movement distance.

FIG. 16 is a perspective view showing an example of a configuration of an end effector.

FIG. 17 is a front view of the end effector shown in FIG. 16.

FIG. 18 is a bottom view of the end effector shown in FIG. 16.

FIG. 19 is a diagram for explanation of a reason why an interval and another interval are smaller than still another interval.

FIG. 20 is a perspective view of the end effector when a relative position of a B-th base to an A-th base is a B-th position.

FIG. 21 is a front view of the end effector shown in FIG. 20.

FIG. 22 is a bottom view of the end effector shown in FIG. 20.

### DESCRIPTION OF EMBODIMENTS

### Embodiments

Embodiments of the present disclosure will now be described with reference to the drawings.

### Overview of Injection Molding Machine

First, an overview of an injection molding machine according to an embodiment is described.

An injection molding machine according to the embodiment includes an injection molding mechanism that molds a plurality of molded products by injection molding, an arrangement mechanism, a robot, and a sintering device. The injection molding machine may not include any one of the arrangement mechanism and the robot. Or, the injection molding machine may not include the sintering device.

Here, a plurality of molded products molded by the injection molding mechanism are mounted on the arrangement mechanism, and the arrangement mechanism changes the arrangement of the plurality of placed molded products to a predetermined arrangement. Thereby, in the injection molding machine, at a stage prior to sintering of the plurality of molded products by the sintering device, the quantity of the plurality of molded products in a pallet can be increased without complication of the structure of the pallet on which the plurality of molded products are placed in the sintering device. As a result, in the injection molding machine, an increase in manufacturing cost of the molded products may be suppressed. The function of the arrangement mechanism may be a configuration of the robot.

Further, the robot holds the plurality of molded products after the arrangement is changed by the arrangement mechanism, and changes the intervals between the plurality of held molded products. Thereby, in the injection molding machine, at the stage prior to sintering of the plurality of molded products by the sintering device, the quantity of the plurality of molded products in the pallet can be increased without complication of the structure of the pallet on which the plurality of molded products are placed in the sintering device. As a result, in the injection molding machine, an increase in manufacturing cost of the molded products may be suppressed. The function of the robot may be a configuration of the arrangement mechanism.

As below, a configuration of an injection molding machine according to an embodiment and modifications thereof will be described in detail.

### Configuration of Injection Molding Machine

Hereinafter, the configuration of the injection molding machine according to the embodiment will be described with an injection molding machine 1 as an example.

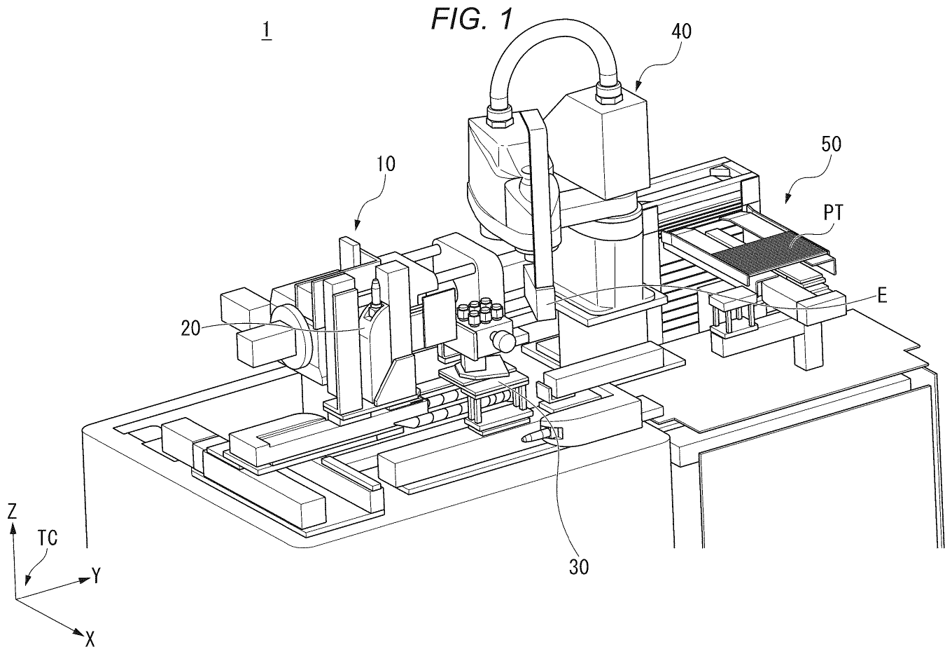

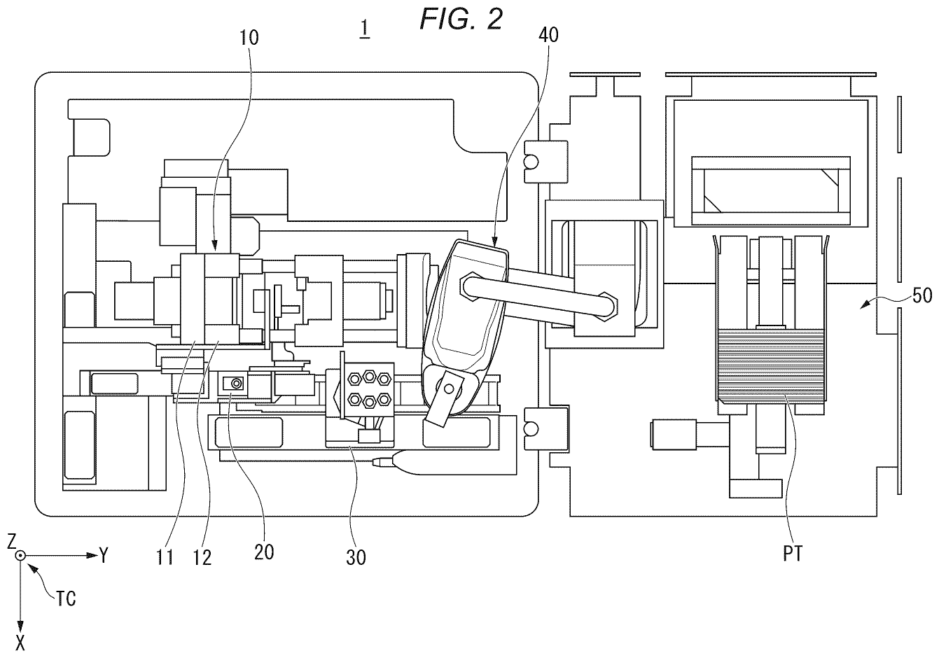

FIG. 1 is a perspective view showing an example of the configuration of the injection molding machine 1. FIG. 2 is a top view of the injection molding machine 1 shown in FIG. 1. However, in FIGS. 1 and 2, in order to clearly show the configuration of the injection molding machine 1, a part of a housing of the injection molding machine 1 is omitted. The part of the housing is, for example, a cover forming at least a part of the outer surface of the injection molding machine 1.

Here, a three-dimensional coordinate system TC is a three-dimensional orthogonal coordinate system indicating directions in the drawing in which the three-dimensional coordinate system TC is drawn. Hereinafter, for convenience of explanation, an X-axis in the three-dimensional coordinate system TC is simply referred to as an X-axis. Hereinafter, for convenience of explanation, a Y-axis in the three-dimensional coordinate system TC is simply referred to as a Y-axis. Hereinafter, for convenience of explanation, a Z-axis in the three-dimensional coordinate system TC is simply referred to as a Z-axis. As below, as example, a case where a negative direction of the Z-axis coincides with the direction of gravity will be described. Accordingly, hereinafter, for convenience of explanation, a positive direction of the Z-axis is referred to as upward or simply as upper, and the negative direction of the Z-axis is referred to as downward or simply as lower.

The injection molding machine 1 is an apparatus molding a plurality of molded products by metal injection molding (MIM). More specifically, the injection molding machine 1 is an apparatus that automatically performs various steps including a molding step of a molded product by MIM, a cleansing step after the molding step, a palletization step after the cleansing step, and a sintering step after the palletization step within the apparatus itself. Hereinafter, for convenience of explanation, the individual molded products molded by the injection molding mechanism 10 are referred to as molded products M.

The injection molding machine 1 includes, for example, an injection molding mechanism 10, a first robot 20, an arrangement mechanism 30, a second robot 40, a sintering device 50, and a control device (not shown). Here, the control device controls the entire injection molding machine 1. The injection molding machine 1 includes other devices such as a cleansing device that cleanses the molded products M before sintering in addition to the first robot 20, the arrangement mechanism 30, the second robot 40, and the sintering device 50. However, in the embodiment, the description of the other devices is omitted. The injection molding machine 1 does not necessarily include the first robot 20. In this case, for example, another device having the function of the first robot 20 is externally coupled to the injection molding machine 1. The injection molding machine 1 may not include any one of the arrangement mechanism 30 and the second robot 40. In this case, for example, another device having the function of the device is externally coupled to the injection molding machine 1. Further, the injection molding machine 1 may not include the sintering device 50. In this case, for example, another device having the function of the sintering device 50 is externally coupled to the injection molding machine 1.

The injection molding mechanism 10 molds a plurality of molded products M by MIM. The injection molding mechanism 10 includes, for example, a material supply nozzle (not shown), a cavity 11 coupled to the material supply nozzle, and a core 12 coupled to the cavity 11. Here, the material supply nozzle supplies a molding material in which metal powder and wax are mixed from a supply device into a space formed between the cavity 11 and the core 12 by coupling of the cavity 11 and the core 12. The injection molding machine 1 may include the supply device or not.

The cavity 11 is a metal mold that is fixed not to move with respect to the housing of the injection molding mechanism 10. The configuration of the cavity 11 may be a known configuration or a configuration to be developed. Accordingly, in the embodiment, the more detailed description of the cavity 11 is omitted.

The core 12 is a movable mold that moves relative to the cavity 11. The configuration of the core 12 may be a known configuration or a configuration to be developed. Accordingly, in the embodiment, the more detailed description of the core 12 is omitted.

In the example shown in FIGS. 1 and 2, the injection molding mechanism 10 moves the core 12 closer to the cavity 11, which is fixed not to move with respect to the housing of the injection molding mechanism 10, in parallel with the Y-axis, and couples the cavity 11 and the core 12 according to control of the control device. On the other hand, in this example, the injection molding mechanism 10 moves the core 12 in parallel to the Y-axis away from the cavity 11 fixed not to move with respect to the housing of the injection molding mechanism 10 according to control of the control device, and separates the cavity 11 and the core 12.

The method of molding the plurality of molded products M using the cavity 11 and the core 12 by the injection molding mechanism 10 may be a known method or a method to be developed. Accordingly, in the embodiment, the more detailed description of the method is omitted.

The first robot 20 is a robot that transfers the plurality of molded products M molded by the injection molding mechanism 10 to the arrangement mechanism 30. For example, the first robot 20 holds the plurality of molded products M by suction with air, and places each of the plurality of held molded products M in a predetermined placement position. Thereby, the first robot 20 transfers the plurality of molded products M to the arrangement mechanism 30. The placement positions refer to positions predetermined as positions where the plurality of molded products M are placed on the arrangement mechanism 30. The configuration of the first robot 20 may be any configuration as long as each of the plurality of molded products M can be placed in the placement position.

The arrangement mechanism 30 is a mechanism that receives the plurality of molded products M transferred from the first robot 20 and changes the arrangement of the plurality of transferred molded products M. After changing the arrangement of the transferred plurality of molded products M, the arrangement mechanism 30 transfers the plurality of molded products M in the changed placement to the second robot 40.

The arrangement mechanism 30 includes two or more bases whose relative positions to one another can be changed. The first robot 20 places the respective plurality of molded products M on the two or more bases in a distributed manner. That is, after the plurality of molded products M are transferred from the first robot 20, at least one molded product M is placed on each of the two or more bases provided in the arrangement mechanism 30. The arrangement mechanism 30 changes the arrangement of the plurality of placed molded products M by changing the relative position of the two or more bases on which the plurality of molded products M are placed in the distributed manner.

Here, the arrangement of the plurality of molded products M before the arrangement is changed by the arrangement mechanism 30 may be any arrangement, and for example, may be an annular arrangement, a radial arrangement, or another arrangement. The annular arrangement is an arrangement in which the plurality of molded products M are annularly arranged. The radial arrangement is an arrangement in which the plurality of molded products M are radially arranged. Hereinafter, for convenience of description, the arrangement of the plurality of molded products M before the arrangement is changed by the arrangement mechanism 30 is referred to as an arrangement at molding. This is because the first robot 20 transfers the plurality of molded products M to the arrangement mechanism 30 without changing the arrangement of the plurality of molded products M molded by the injection molding mechanism 10. As below, a case where the molding arrangement is an annular arrangement will be described as an example.

Further, the arrangement of the plurality of molded products M after the arrangement is changed by the arrangement mechanism 30 may be any arrangement, and for example, may be a one-line arrangement, a two-line arrangement, or another arrangement. The one-line arrangement is an arrangement in which the plurality of molded products M are arranged on one straight line. The two-line arrangement is an arrangement in which the plurality of molded products M are arranged on two straight lines parallel to each other. Hereinafter, for convenience of description, the arrangement of the plurality of molded products M after the arrangement is changed by the arrangement mechanism 30 is referred to as a changed arrangement. As below, a case where the changed arrangement is a two-line arrangement will be described as an example.

Hereinafter, for convenience of description, among the relative positions of the two or more bases of the arrangement mechanism 30, a position in which the arrangement mechanism 30 receives the plurality of molded products M from the first robot 20 is referred to as a first position. That is, when the relative position among the two or more bases is the first position, the arrangement of the plurality of molded products M placed on the arrangement mechanism 30 is the arrangement at molding. Hereinafter, for convenience of description, the relative position among the two or more bases when the plurality of molded products M are transferred from the arrangement mechanism 30 to the second robot 40 is referred to as a second position. That is, when the relative position among the two or more bases is the second position, the arrangement of the plurality of molded products M placed on the arrangement mechanism 30 is the changed arrangement.

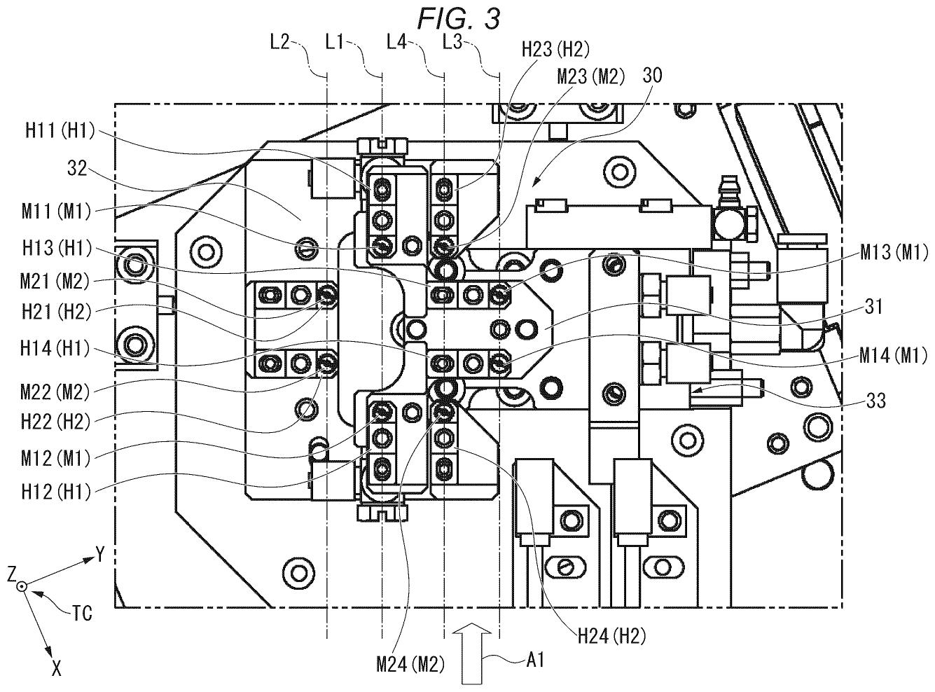

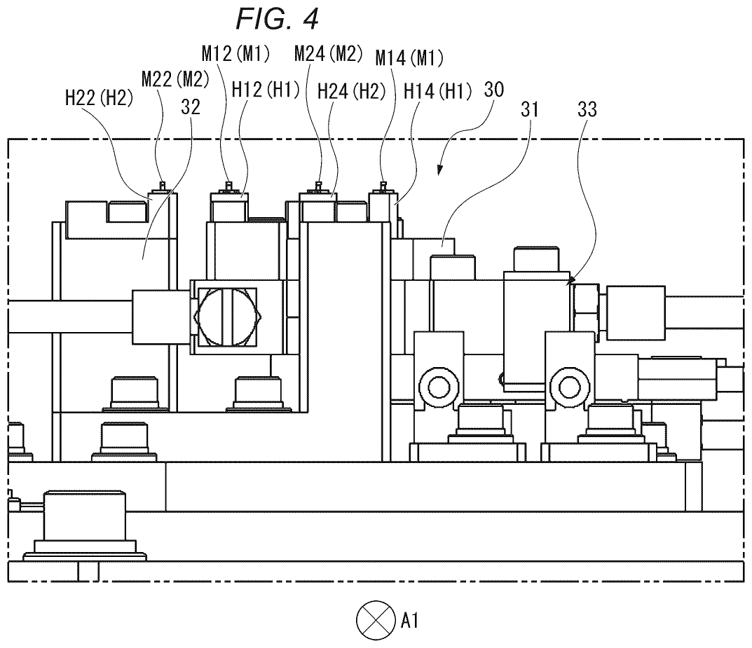

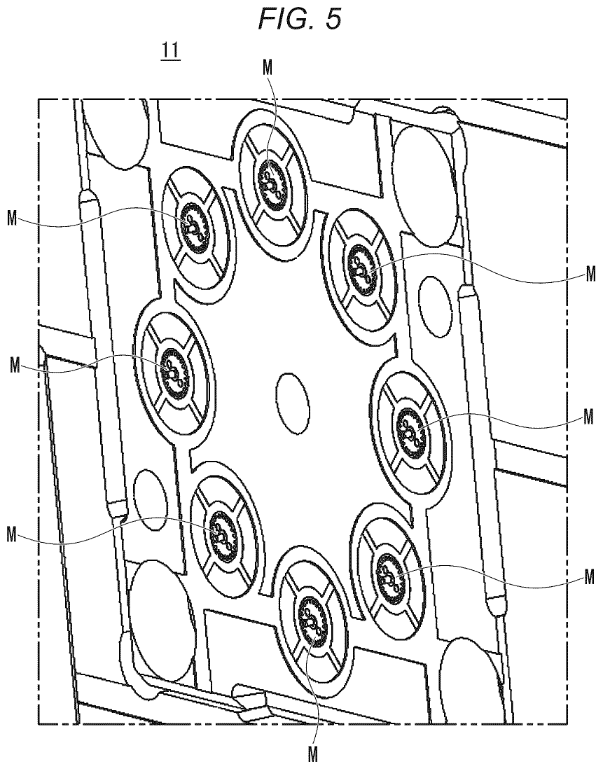

When the arrangement at molding is the annular arrangement, the arrangement mechanism 30 has, for example, a configuration as shown in FIGS. 3 and 4. FIG. 3 is a top view showing an example of the configuration of the arrangement mechanism 30. FIG. 4 is a side view of the arrangement mechanism 30 as seen in a direction indicated by an arrow A1 shown in FIG. 3. As below, a case where the number of the plurality of molded products M molded by the injection molding mechanism 10 is eight will be described as an example. In this case, as described above, in the injection molding mechanism 10, as shown in FIG. 5, the eight molded products M are molded in an annular arrangement. FIG. 5 shows an example of a configuration of a surface of the core 12 facing the cavity 11. In the example shown in FIG. 5, in the injection molding mechanism 10, the eight molded products M are molded in the annular arrangement between the cavity 11 and the core 12. When the arrangement at molding is the annular arrangement, the injection pressure of the molding material into the space between the cavity 11 and the core 12 is equalized. As a result, the injection molding mechanism 10 can reduce individual differences in dimensions and the like of the molded product M due to variations in injection pressure.

In the example shown in FIGS. 3 and 4, the arrangement mechanism 30 includes two bases of the first base 31 and the second base 32 as the above described two or more bases. In the arrangement mechanism 30, the relative position of the first base 31 to the second base 32 can be changed. The arrangement mechanism 30 can move the second base 32 relative to the first base 31, move the first base 31 relative to the second base 32, or move both the first base 31 and the second base 32 relative to each other. As below, a case where the arrangement mechanism 30 is configured to move the first base 31 relative to the second base 32 will be described as an example. Further, as below, a case where the first base 31 is movable in parallel to a direction orthogonal to both the direction indicated by the arrow A1 and the gravity direction will be described as an example.

The first base 31 is, for example, a base on which the respective four molded products M of the eight molded products M molded by the injection molding mechanism 10 are placed as first molded products M1. An A-th holding portion H11, an A-th holding portion H12, an A-th holding portion H13, and an A-th holding portion H14 are each provided on the upper surface of the first base 31. Hereinafter, for convenience of description, unless it is necessary to distinguish the A-th holding portion H11, the A-th holding portion H12, the A-th holding portion H13, and the A-th holding portion H14, the portions are collectively referred to as an A-th holding portion H1. Note that the first base 31 may have any configuration instead as long as the base can hold the four first molded products M1.

The A-th holding portion H1 is a member that holds the first molded product M1 on the first base 31. In the A-th holding portion H1, an air suction port is formed in parallel to the Z-axis. The A-th holding portion H1 can hold the first molded product M1 placed directly above the suction port by suction of air through the suction port. The A-th holding portion H1 may be configured to hold the first molded product M1 using another method instead of air suction.

Hereinafter, for convenience of description, the first molded product M1 held by the A-th holding portion H11 is referred to as a first molded product M11. Hereinafter, for convenience of description, the first molded product M1 held by the A-th holding portion H12 is referred to as a first molded product M12. Hereinafter, for convenience of description, the first molded product M1 held by the A-th holding portion H13 is referred to as a first molded product M13. Hereinafter, for convenience of description, the first molded product M1 held by the A-th holding portion H14 is referred to as a first molded product M14.

On the other hand, the second base 32 is a base on which the respective remaining four molded products M except the four first molded products M1 of the eight molded products M molded by the injection molding mechanism 10 are placed as second molded products M2. A B-th holding portion H21, a B-th holding portion H22, a B-th holding portion H23, and a B-th holding portion H24 are each provided on the upper surface of the second base 32. Hereinafter, for convenience of description, unless it is necessary to distinguish the B-th holding portion H21, the B-th holding portion H22, the B-th holding portion H23, and the B-th holding portion H24, the portions are collectively referred to as a B-th holding portion H2. Note that the second base 32 may have any configuration as long as the base can hold the four second molded products M2.

The B-th holding portion H2 is a member that holds the second molded product M2 on the second base 32. In the B-th holding portion H2, an air suction port is formed in parallel to the Z-axis. The B-th holding portion H2 can hold the second molded product M2 placed directly above the suction port by suction of air through the suction port. The second holding portion HD2 may be configured to hold the second molded product M2 using another method instead of air suction.

Hereinafter, for convenience of description, the second molded product M2 held by the B-th holding portion H21 is referred to as a second molded product M21. Hereinafter, for convenience of description, the second molded product M2 held by the B-th holding portion H22 is referred to as a second molded product M22. Hereinafter, for convenience of description, the second molded product M2 held by the B-th holding portion H23 is referred to as a second molded product M23. Hereinafter, for convenience of description, the second molded product M2 held by the B-th holding portion H24 is referred to as a second molded product M24.

Here, the upper surfaces of the four A-th holding portions H1 and the upper surfaces of the four B-th holding portions H2 are surfaces contained in a virtual plane parallel to both the X-axis and the Y-axis. That is, the upper surfaces of the four A-th holding portions H1 and the upper surfaces of the four B-th holding portions H2 have the same height in the gravity direction except for differences due to manufacturing errors or the like. Accordingly, the eight molded products M placed on the arrangement mechanism 30 have the same height in the gravity direction except for differences due to manufacturing errors or the like.

In the example shown in FIG. 3, the relative position of the first base 31 to the second base 32 is the above described first position. Accordingly, in this example, the arrangement of the eight molded products M placed on the arrangement mechanism 30 is maintained to remain the arrangement at molding, and is the annular arrangement. That is, in the example, when the relative position is the first position, the A-th holding portion H1 is provided on the first base 31 and the B-th holding portion H2 is provided on the second base 32 so that the arrangement of the eight molded products M is maintained to remain the arrangement at molding.

Here, each of the four A-th holding portions H1 on the first base 31 and the four B-th holding portions H2 on the second base 32 is provided to satisfy the following six conditions of conditions 1 to 6 when the relative position of the first base 31 to the second base 32 is the first position.

(Condition 1) Each of the first molded product M11 held by the A-th holding portion H11 and the first molded product M12 held by the A-th holding portion H12 is positioned on a virtual first straight line L1 predetermined for the first base 31.

(Condition 2) Each of the second molded product M21 held by the B-th holding portion H21 and the second molded product M22 held by the B-th holding portion H22 is positioned on a virtual second straight line L2 predetermined for the second base 32.

(Condition 3) Each of the first molded product M13 held by the A-th holding portion H13 and the first molded product M14 held by the A-th holding portion H14 is positioned on a virtual third straight line L3 predetermined for the first base 31.

(Condition 4) Each of the second molded product M23 held by the B-th holding portion H23 and the second molded product M24 held by the B-th holding portion H24 is positioned on a virtual fourth straight line L4 predetermined for the second base 32.

### Condition 5

The first molded product M11, the first molded product M12, the first molded product M13, the first molded product M14, the second molded product M21, the second molded product M22, the second molded product M23, and the second molded product M24 are located on a predetermined circumference C.

### Condition 6

The distances between the two adjacent molded products M of the eight molded products M of the first molded product M11, the first molded product M12, the first molded product M13, the first molded product M14, the second molded product M21, the second molded product M22, the second molded product M23, and the second molded product M24 are the same on the circumference C.

Here, each of the first straight line L1 and the third straight line L3 is a straight line predetermined for the first base 31 as a straight line orthogonal to both a direction in which the first base 31 can move closer to the second base 32 and the gravity direction. Further, each of the second straight line L2 and the fourth straight line L4 is a predetermined for the second base 32 as a straight line orthogonal to both a direction in which the second base 32 can move closer to the first base 31 and the gravity direction. In the example shown in FIG. 3, the direction in which the first base 31 can move closer to the second base 32 is a direction from the second base 32 toward the first base 31 of two directions orthogonal to the direction indicated by the arrow A1 in FIG. 3. Accordingly, in this example, each of the first straight line L1, the second straight line L2, the third straight line L3, and the fourth straight line L4 is a straight line parallel to the direction indicated by the arrow A1. Further, in the example, the first straight line L1, the second straight line L2, the third straight line L3, and the fourth straight line L4 are arranged in a direction from the second straight line L2 toward the first straight line L1 in the order of the second straight line L2, the first straight line L1, the fourth straight line L4, and the third straight line L3.

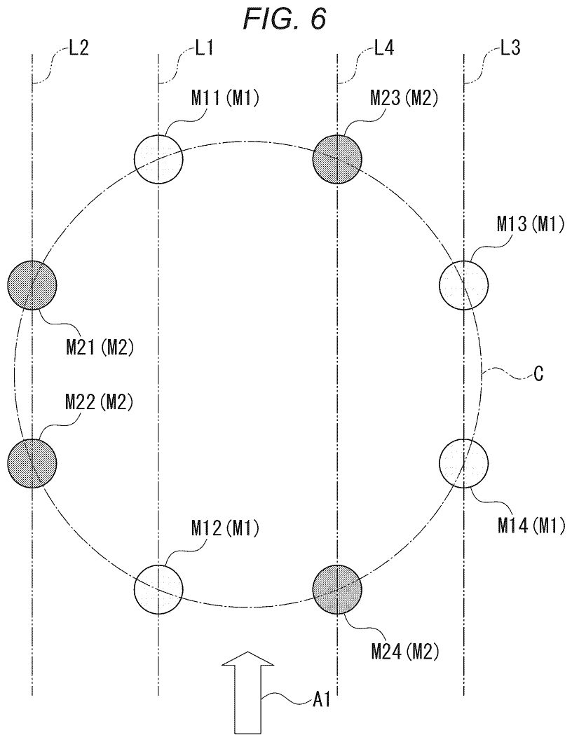

FIG. 6 shows an arrangement of the eight molded products M placed on the arrangement mechanism 30 shown in FIG. 3. In FIG. 6, in order to clearly show the arrangement, only the eight molded products M and a plurality of auxiliary lines are shown, and the other members and the like are omitted.

As shown in FIG. 6, when the relative position of the first base 31 to the second base 32 is the first position, the eight molded products M are located on the circumference C so that the distances between the two adjacent molded products M are the same. That is, on the circumference C, the distance between the second molded product M21 and the first molded product M11, the distance between the first molded product M11 and the second molded product M23, the distance between the second molded product M23 and the first molded product M13, the distance between the first molded product M13 and the first molded product M14, the distance between the first molded product M14 and the second molded product M24, the distance between the second molded product M24 and the first molded product M12, the distance between the first molded product M12 and the second molded product M22, and the distance between the second molded product M22 and the second molded product M21 are the same as one another. This means that the above described conditions 5 and 6 are satisfied in the example shown in FIG. 3.

As shown in FIG. 6, when the relative position of the first base 31 to the second base 32 is the first position, the first molded product M11 and the first molded product M12 are located on the first straight line L1. In this case, the second molded product M21 and the second molded product M22 are located on the second straight line L2. Further, in this case, the first molded product M13 and the first molded product M14 are located on the third straight line L3. In this case, the second molded product M23 and the second molded product M24 are located on the fourth straight line L4. Here, when the eight molded products M are seen from a direction orthogonal to each of the first straight line L1 to the fourth straight line L4 in FIG. 6, the second molded product M21 and the second molded product M22 are located between the first molded product M11 and the first molded product M12. In this case, the first molding article M13 and the first molding article M14 are located between the second molding article M23 and the second molding article M24. Further, in this case, the first molded product M11 overlaps with the second molded product M23. In this case, the first molded product M12 overlaps with the second molded product M24. In this case, the second molding product M21 overlaps with the first molding product M13. In this case, the second molding product M22 overlaps with the first molding product M14. On the first straight line L1, the first molded product M11 and the first molded product M12 are arranged in the order of the first molded product M12 and the first molded product M11 in the direction indicated by the arrow A1. On the second straight line L2, the second molding product M21 and the second molding product M22 are arranged in the order of the second molding product M22 and the second molding product M21 in the direction indicated by the arrow A1. On the third straight line L3, the first molded product M13 and the first molded product M14 are arranged in the order of the first molded product M14 and the first molded product M13 in the direction indicated by the arrow A1. On the fourth straight line L4, the second molded product M23 and the second molded product M24 are arranged in the order of the second molded product M24 and the second molded product M23 in the direction indicated by the arrow A1. The distance between the first straight line L1 and the second straight line L2 is the same as the distance between the third straight line L3 and the fourth straight line L4 except for differences due to manufacturing errors or the like. Hereinafter, for convenience of description, the distance between the first straight line L1 and the second straight line L2 is referred to as a first base movement distance.

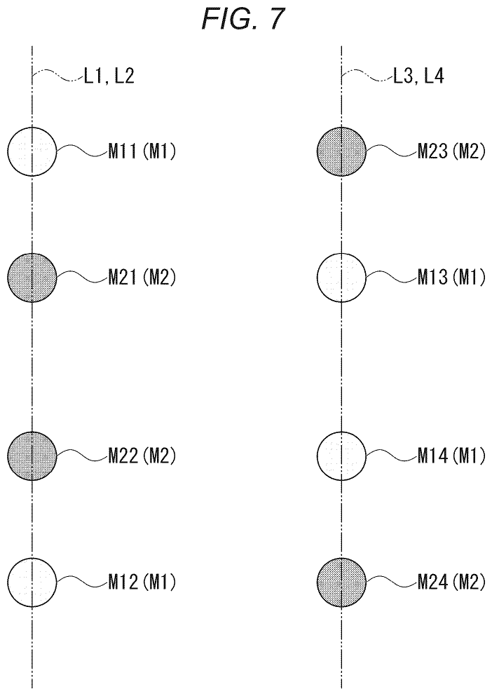

Here, when the first base 31 moves closer to the second base 32 by the first base movement distance, the first straight line L1 shown in FIG. 6 moves with the first base 31. As a result, in this case, the first straight line L1 overlaps with the second straight line L2. That is, in this case, the first molded product M11 and the first molded product M12 are located on the second straight line L2 with each of the second molded product M21 and the second molded product M22. On the other hand, in this case, the third straight line L3 shown in FIG. 6 moves with the first base 31. As a result, in this case, the third straight line L3 overlaps with the fourth straight line L4. That is, in this case, each of the first molded product M13 and the first molded product M14 is located on the fourth straight line L4 with each of the second molded product M23 and the second molded product M24. That is, of the positions where the first base 31 can be located, the position where the first base 31 moves closer to the second base 32 by the first base movement distance is an example of the above described second position. FIG. 7 shows an arrangement after the arrangement of the eight molded products M shown in FIG. 6 is changed as the first base 31 moves closer to the second base 32 by the first base movement distance. As shown in FIG. 7, when the first base 31 moves closer to the second base 32 by the first base movement distance, that is, when the relative position of the first base 31 to the second base 32 is the second position, the arrangement of the eight molded products M in the annular arrangement in FIG. 6 is changed to the two-line arrangement.

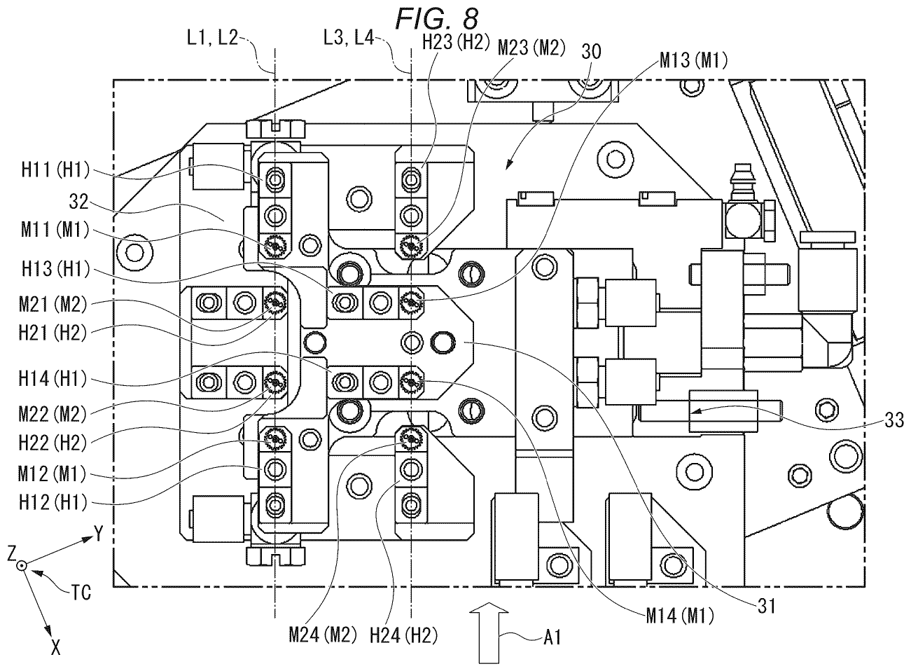

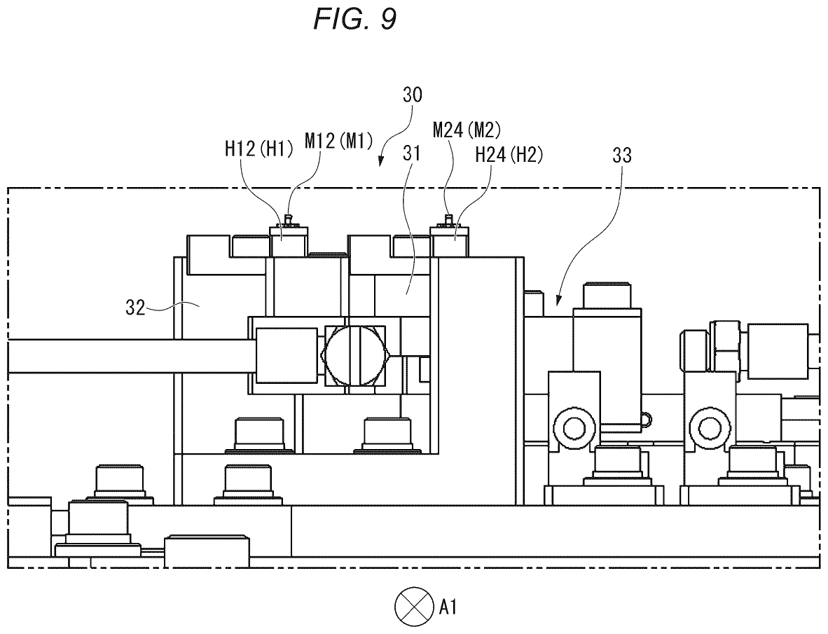

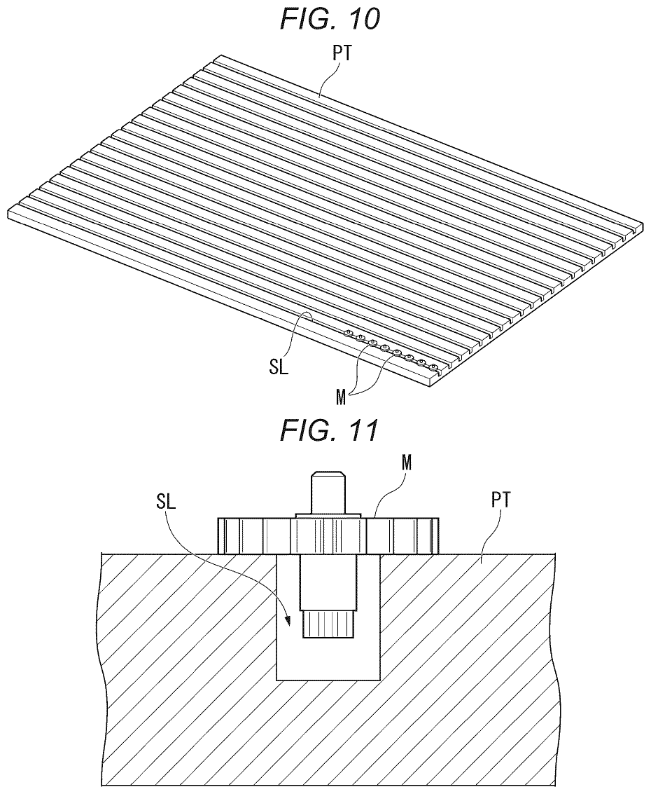

FIG. 8 is a top view showing an example of a state after the relative position of the first base 31 to the second base 32 is changed to the second position in the arrangement mechanism 30 shown in FIG. 3. FIG. 9 is a side view of the arrangement mechanism 30 as seen in the direction indicated by an arrow A1 shown in FIG. 8. The relative position of the first base 31 to the second base 32 shown in FIG. 8 is an example of the second position. As shown in FIGS. 8 and 9, the arrangement mechanism 30 moves the relative position of the first base 31 to the second base 32 to the second position, and thereby, the arrangement of the eight molded products M in the annular arrangement as the arrangement at molding may be changed to the two-line arrangement as an example of the changed arrangement. That is, the arrangement mechanism 30 can change the arrangement of the eight molded products M by a simple structure that changes the relative distance between the two bases. As a result, the injection molding machine 1 can increase, for example, the quantity of molded products M in the pallet. Here, the plurality of molded products M arranged in a two-line arrangement enables palletization to a pallet having a simple structure as shown in FIG. 10. FIG. 10 shows an example of a pallet PT in which a plurality of linear grooves for placement of the molded products M are formed. FIG. 11 shows an example of a state in which a certain molded product M is placed in a certain groove SL among the plurality of linear grooves formed in the pallet PT shown in FIG. 10. In the injection molding machine 1, the pallet PT is made of, for example, ceramic. This is because the plurality of molded products M placed on the pallet PT are heated with the pallet PT in the sintering device 50. It is known that the manufacturing cost of the ceramic pallet PT increases as the structure becomes complicated. An increase in the manufacturing cost of the pallet PT is not desirable because the increase causes an increase in the sales price of the individual molded products M. Under such circumstances, simplification of the structure of the pallet PT is important to suppress the increase in the sales price of the individual molded products M. Therefore, the injection molding machine 1 can suppress the increase in the sales price of the individual molded products M by changing the arrangement of the plurality of molded products M using the arrangement mechanism 30.

Note that, when the relative position of the first base 31 to the second base 32 is the first position, each of the four A-th holding portions H1 on the first base 31 and the four B-th holding portions H2 on the second base 32 may be provided to satisfy other conditions instead of the configuration provided to satisfy the six conditions of the above described conditions 1 to 6. For example, each of the four A-th holding portions H1 on the first base 31 and the four B-th holding portions H2 on the second base 32 may be provided to satisfy the four conditions of the above described conditions 1 to 4. Further, for example, each of the four A-th holding portions H1 on the first base 31 and the four B-th holding portions H2 on the second base 32 may be provided to satisfy one or more other conditions not contained in the six conditions of the above described conditions 1 to 6.

The above described arrangement mechanism 30 has the configuration in which four of the first molded products M1 are placed on the first base 31 and four of the second molded products M2 are placed on the second base 32, however, may have a configuration in which three of the first molded products M1 are placed on the first base 31 and three of the second molded products M2 are placed on the second base 32 instead. In this case, when the relative position of the first base 31 to the second base 32 is the first position, the three A-th holding portions H1 are provided on the first base 31 and the three B-th holding portions H2 are provided on the second base 32 to satisfy the following six conditions of conditions 7 to 12. As below, as an example, a case where the three A-th holding portions H1 provided on the first base 31 are the A-th holding portion H11, the A-th holding portion H12, and the A-th holding portion H13 will be described. Further, as below, as an example, a case where the three B-th holding portions H2 provided on the second base 32 are the B-th holding portion H21, the B-th holding portion H22, and the B-th holding portion H23 will be described.

(Condition 7) Each of the first molded product M11 held by the A-th holding portion H11 and the first molded product M12 held by the A-th holding portion H12 is positioned on a virtual first straight line L1 predetermined for the first base 31.

(Condition 8) The second molded product M21 held by the B-th holding portion H21 is located on a virtual second straight line L2 predetermined for the second base 32.

(Condition 9) The first molded product M13 held by the A-th holding portion H13 is located on a virtual third straight line L3 predetermined for the first base 31.

(Condition 10) Each of the second molded product M22 held by the B-th holding portion H22 and the second molded product M23 held by the B-th holding portion H23 is located on a virtual fourth straight line L4 predetermined for the second base 32.

### Condition 11

The first molded product M11, the first molded product M12, the first molded product M13, the second molded product M21, the second molded product M22, and the second molded product M23 are located on a predetermined circumference C.

### Condition 12

Distances between two adjacent molded products M on the circumference C of the six molded products M of the first molded product M11, the first molded product M12, the first molded product M13, the second molded product M21, the second molded product M22, and the second molded product M23 are the same.

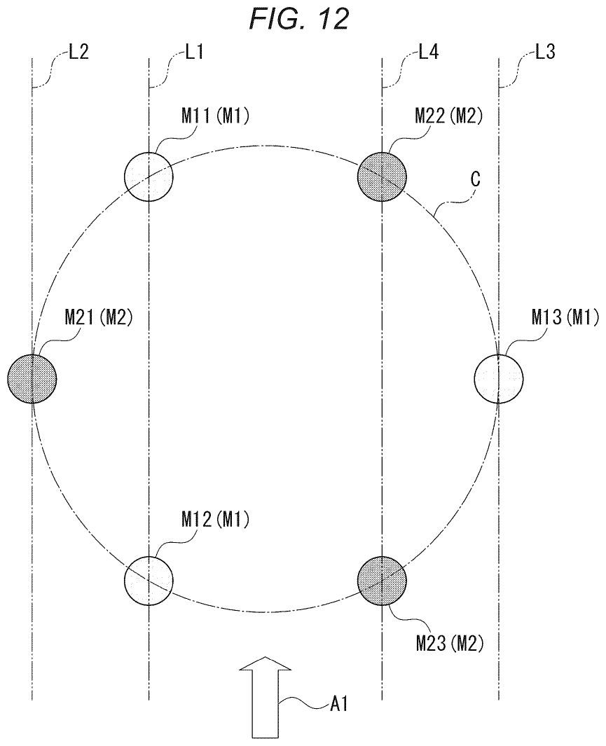

FIG. 12 shows an example of the arrangement of the six molded products M placed on the arrangement mechanism 30 when the relative position of the first base 31 to the second base 32 is the first position. In FIG. 12, in order to clearly show the arrangement, only the six molded products M and a plurality of auxiliary lines are shown, and other members and the like are omitted.

As shown in FIG. 12, when the relative position of the first base 31 to the second base 32 is the first position, the six molded products M are located on the circumference C so that the distances between the two adjacent molded products M are the same. That is, on the circumference C, the distance between the second molded product M21 and the first molded product M11, the distance between the first molded product M11 and the second molded product M22, the distance between the second molded product M22 and the first molded product M13, the distance between the first molded product M13 and the second molded product M23, the distance between the second molded product M23 and the first molded product M12, and the distance between the first molded product M12 and the second molded product M21 are the same. This means that the above described conditions 11 and 12 are satisfied.

As shown in FIG. 12, when the relative position of the first base 31 to the second base 32 is the first position, the first molded product M11 and the first molded product M12 are located on the first straight line L1. In this case, the second molded product M21 is located on the second straight line L2. In this case, the first molded product M13 is located on the third straight line L3. In this case, the second molding product M22 and the second molding product M23 are located on the fourth straight line L4. Here, when the six molded products M are seen from a direction orthogonal to each of the first straight line L1 to the fourth straight line L4 in FIG. 12, the second molded product M21 is located between the first molded product M11 and the first molded product M12. In this case, the first molded product M13 is located between the second molded product M22 and the second molded product M23. In this case, the first molded product M11 overlaps with the second molded product M22. In this case, the first molded product M12 overlaps with the second molded product M23. In this case, the second molding product M21 overlaps with the first molding product M13. On the first straight line L1, the first molded product M11 and the first molded product M12 are arranged in the order of the first molded product M12 and the first molded product M11 in the direction indicated by the arrow A1. On the fourth straight line L4, the second molding product M22 and the second molding product M23 are arranged in the order of the second molding product M23 and the second molding product M22 in the direction indicated by the arrow A1. The distance between the first straight line L1 and the second straight line L2 is the same as the distance between the third straight line L3 and the fourth straight line L4 except for differences due to manufacturing errors or the like. Hereinafter, for convenience of description, the distance between the first straight line L1 and the second straight line L2 is referred to as a second base movement distance.

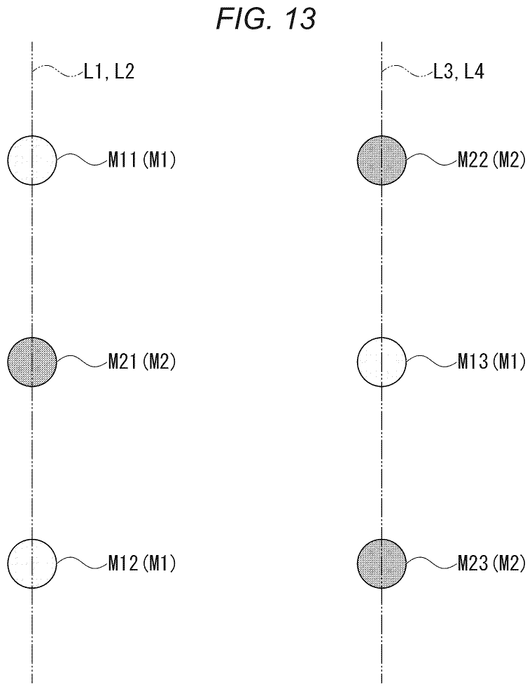

Here, when the first base 31 moves closer to the second base 32 by the second base movement distance, the first straight line L1 shown in FIG. 12 moves with the first base 31. As a result, in this case, the first straight line L1 overlaps with the second straight line L2. That is, in this case, each of the first molded product M11 and the first molded product M12 is located on the second straight line L2 with the second molded product M21. On the other hand, in this case, the third straight line L3 shown in FIG. 12 moves with the first base 31. As a result, in this case, the third straight line L3 overlaps with the fourth straight line L4. That is, in this case, the first molded product M13 is located on the fourth straight line L4 with each of the second molded product M22 and the second molded product M23. That is, among the positions where the first base 31 can be located, the position where the first base 31 moves closer to the second base 32 by the second base movement distance is an example of the above described second position. FIG. 13 shows an arrangement after the arrangement of the six molded products M shown in FIG. 12 is changed when the first base 31 moves closer to the second base 32 by the second base movement distance. As shown in FIG. 13, when the first base 31 moves closer to the second base 32 by the second base movement distance, that is, when the relative position of the first base 31 to the second base 32 is the second position, the arrangement of the six molded products M in the annular arrangement in FIG. 12 is changed to the two-line arrangement.

Further, the above described arrangement mechanism 30 has the configuration in which three of the first molded products M1 are placed on the first base 31 and three of the second molded products M2 are placed on the second base 32, however, may have a configuration in which two of the first molded products M1 are placed on the first base 31 and two of the second molded products M2 are placed on the second base 32 instead. In this case, when the relative position of the first base 31 to the second base 32 is the first position, two A-th holding portions H1 are provided on the first base 31 and one B-th holding portion H2 is provided on the second base 32 to satisfy the following four conditions of conditions 13 to 16. As below, as an example, a case where the two A-th holding portions H1 provided on the first base 31 are the A-th holding portion H11 and the A-th holding portion H12 will be described. Further, as below, as an example, a case where one B-th holding portion H2 provided on the second base 32 is the B-th holding portion H21 will be described.

(Condition 13) Each of the first molded product M11 held by the A-th holding portion H11 and the first molded product M12 held by the A-th holding portion H12 is located on a virtual first straight line L1 predetermined for the first base 31.

(Condition 14) The second molded product M21 held by the B-th holding portion H21 is located on a virtual second straight line L2 predetermined for the second base 32.

### Condition 15

The first molded product M11, the first molded product M12, and the second molded product M21 are located on a predetermined circumference C.

### Condition 16

Distances between two adjacent molded products M on the circumference C of the three molded products M of the first molded product M11, the first molded product M12, and the second molded product M21 are the same.

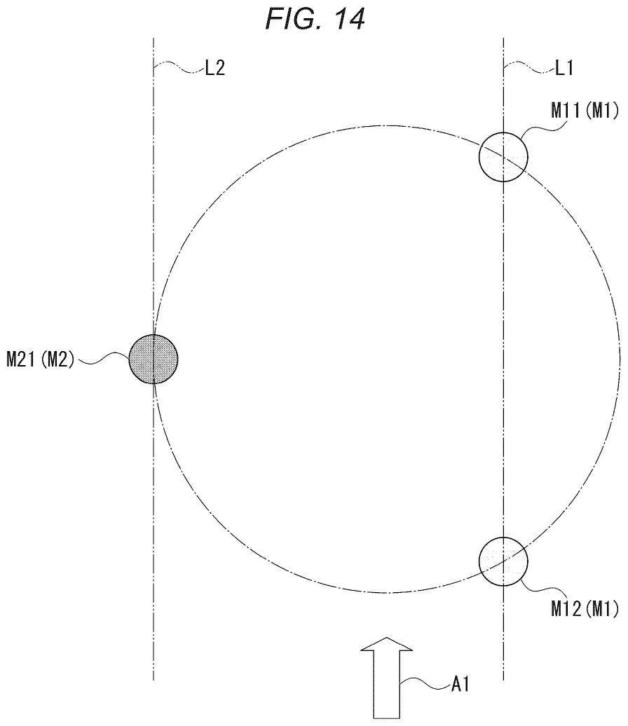

FIG. 14 shows an example of the arrangement of the three molded products M placed on the arrangement mechanism 30 when the relative position of the first base 31 to the second base 32 is the first position. In FIG. 14, in order to clearly show the arrangement, only the three molded products M and a plurality of auxiliary lines are shown, and the other members and the like are omitted.

As shown in FIG. 14, when the relative position of the first base 31 to the second base 32 is the first position, the three molded products M are located on the circumference C so that the distances between the two adjacent molded products M are the same. That is, on the circumference C, the distance between the second molded product M21 and the first molded product M11, the distance between the first molded product M11 and the first molded product M12, and the distance between the first molded product M12 and the second molded product M21 are the same as one another. This means that the above described conditions 15 and 16 are satisfied.

As shown in FIG. 14, when the relative position of the first base 31 to the second base 32 is the first position, the first molded product M11 and the first molded product M12 are located on the first straight line L1. In this case, the second molded product M21 is located on the second straight line L2. Here, when three molded products M are viewed from a direction orthogonal to each of the first straight line L1 and the second straight line L2 in FIG. 14, the second molded product M21 is located between the first molded product M11 and the first molded product M12. On the first straight line L1, the first molded product M11 and the first molded product M12 are arranged in the order of the first molded product M12 and the first molded product M11 in the direction indicated by the arrow A1. Hereinafter, for convenience of description, the distance between the first straight line L1 and the second straight line L2 is referred to as a third base movement distance.

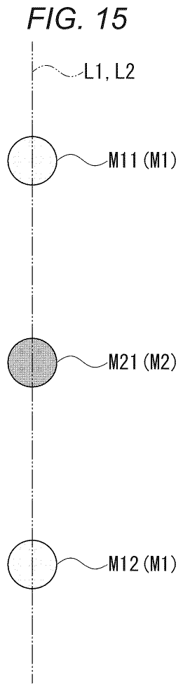

Here, when the first base 31 moves closer to the second base 32 by the third base movement distance, the first straight line L1 shown in FIG. 14 moves with the first base 31. As a result, in this case, the first straight line L1 overlaps with the second straight line L2. That is, in this case, each of the first molded product M11 and the first molded product M12 is located on the second straight line L2 with the second molded product M21. Of the positions where the first base 31 can be located, the position where the first base 31 moves closer to the second base 32 by the third base movement distance is an example of the above described second position. FIG. 15 shows an arrangement after the arrangement of the three molded products M shown in FIG. 14 is changed when the first base 31 moves closer to the second base 32 by the third base movement distance. As shown in FIG. 15, when the first base 31 moves closer to the second base 32 by the third base movement distance, that is, when the relative position of the first base 31 to the second base 32 is the second position, the arrangement of the three molded products M in the annular arrangement in FIG. 14 is changed to the above described one-line arrangement. Also in this case, the injection molding machine 1 can increase, for example, the quantity of molded products M in the pallet PT. Also in this case, the injection molding machine 1 can simplify the structure of the pallet PT, and as a result, can suppress an increase in the sales price of the individual molded products M.

The above described arrangement mechanism 30 may have a configuration in which three or more molded products M are placed and the arrangement of these three or more molded products Mis changed. For example, the number of molded products M placed on the arrangement mechanism 30 may be 4, 5, 9, 11, or the like. However, when the number of molded products M placed on the arrangement mechanism 30 is 5, 9, or 11, the number of molded products M placed on the first base 31 is different from the number of molded products M placed on the second base 32 as shown in FIGS. 14 and 15. Here, when nine or more molded products M are placed, the arrangement mechanism 30 includes three or more bases having one or more other bases in addition to the first base 31 and the second base 32. Thereby, the arrangement mechanism 30 can change the arrangement of the nine or more molded products M by changing the relative position of the three or more bases. For example, the arrangement mechanism 30 can change the arrangement of an even number, 10, 12, or 14 or more of molded products M by changing the relative position of the three or more bases. However, in the injection molding industry, the practical number of molded products M placed on the arrangement mechanism 30 is about eight. This is because the structure or the like of the injection molding mechanism 10 becomes too complicated when molding of more than eight molded products M is performed.

Here, the arrangement mechanism 30 further includes a first base movement unit 33 that changes the relative position of the two bases of the first base 31 and the second base 32. Further, the arrangement mechanism 30 includes a housing in which the first base 31, the second base 32, and the first base movement unit 33 are provided. The arrangement mechanism 30 may include other members, other devices, and the like in addition to the first base 31, the second base 32, the first base movement unit 33, and the housing of the arrangement mechanism 30.

In this example, the second base 32 is fixed to the housing of the arrangement mechanism 30, and the first base 31 is movable with respect to the second base 32 fixed to the housing of the arrangement mechanism 30. Therefore, the first base movement unit 33 changes the relative position of the two bases of the first base 31 and the second base 32 by moving the first base 31. The first base movement unit 33 may be configured to change the relative position of the two bases of the first base 31 and the second base 32 by moving the second base 32. Further, the first base movement unit 33 may be configured to change the relative position of the two bases of the first base 31 and the second base 32 by moving both the first base 31 and the second base 32.

More specifically, the first base movement unit 33 changes the relative position of the first base 31 to the second base 32 between the first position and the second position by moving the first base 31. For example, the first base movement unit 33 changes the relative position of the first base 31 to the second base 32 between the first position and the second position based on the balance between the air pressure in the air cylinder and the atmospheric pressure. The first base movement unit 33 may have another configuration as long as the relative position of the first base 31 to the second base 32 can be changed between the first position and the second position.

Further, the housing of the arrangement mechanism 30 is movable between a predetermined first transfer position and a predetermined second transfer position. The first transfer position is a position predetermined as a position where the eight molded products M are transferred from the first robot 20 of the positions where the housing of the arrangement mechanism 30 can move. The second transfer position is a position predetermined as a position where the eight molded products M are held by the second robot 40 of positions where the housing of the arrangement mechanism 30 can move. In the example shown in FIGS. 1 and 2, the housing of the arrangement mechanism 30 is movable in parallel to the Y-axis.

The arrangement of the eight molded products M may be changed by the arrangement mechanism 30 in the first robot 20. In this case, the first robot 20 includes at least a part of the configuration of the above described arrangement mechanism 30. In this case, the A-th holding portion H1 and the B-th holding portion H2 serves as a first end effector and a second end effector to hold the molded product M, respectively. In this case, the first robot 20 includes an end effector movement unit that changes the relative position of the two end effector instead of the first base movement unit 33. The arrangement of the eight molded products M may be changed by the arrangement mechanism 30 in the second robot 40. In this case, the second robot 40 includes at least a part of the configuration of the above described arrangement mechanism 30. Also in this case, the A-th holding portion H1 and the B-th holding portion H2 serves as a first end effector and a second end effector to hold the molded product M, respectively. Also in this case, the second robot 40 includes an end effector movement unit that changes the relative position of the two end effectors instead of the first base movement section 33.

The second robot 40 is, for example, a SCARA robot. The second robot 40 may be a single-arm articulated robot, a dual-arm articulated robot, or another type of robot, instead of the SCARA robot.

The second robot 40 includes a support base (not shown) that supports the entire second robot 40, a first arm pivotably supported by the support base, a second arm pivotably supported by the first arm, a shaft penetrating the tip of the second arm in parallel to the gravity direction, and an end effector E provided at the tip of the shaft.

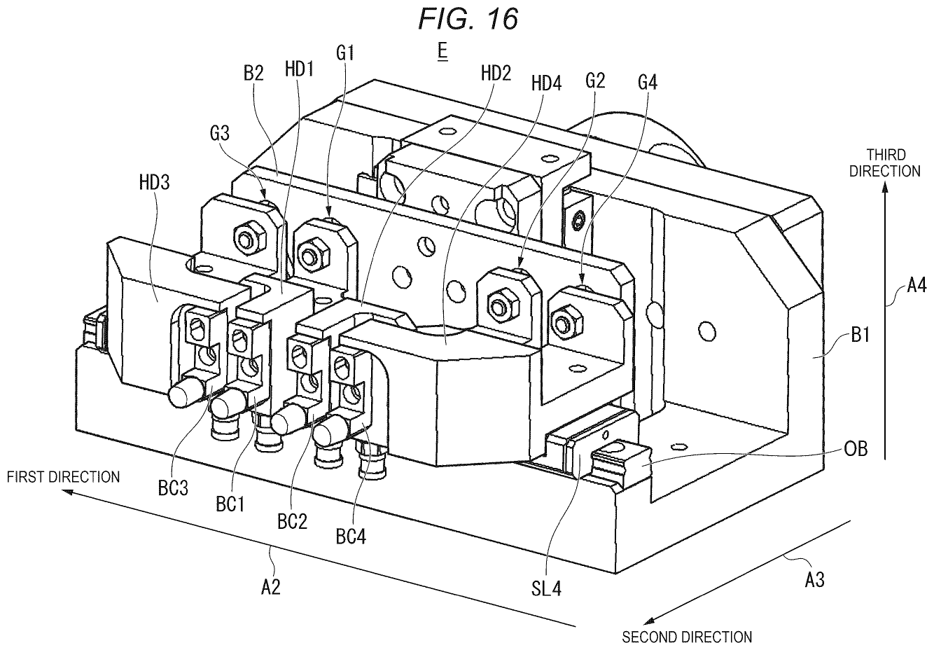

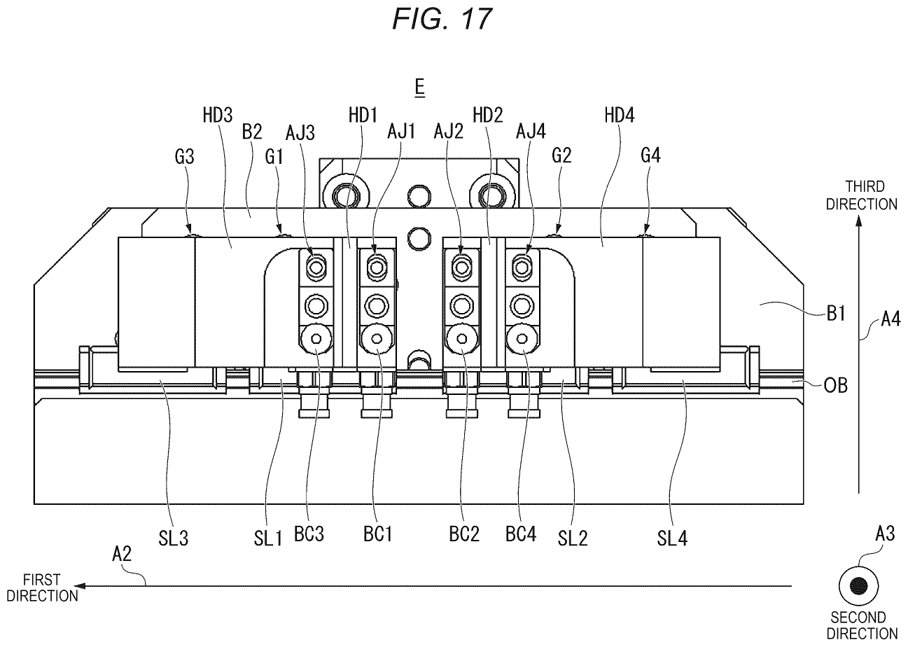

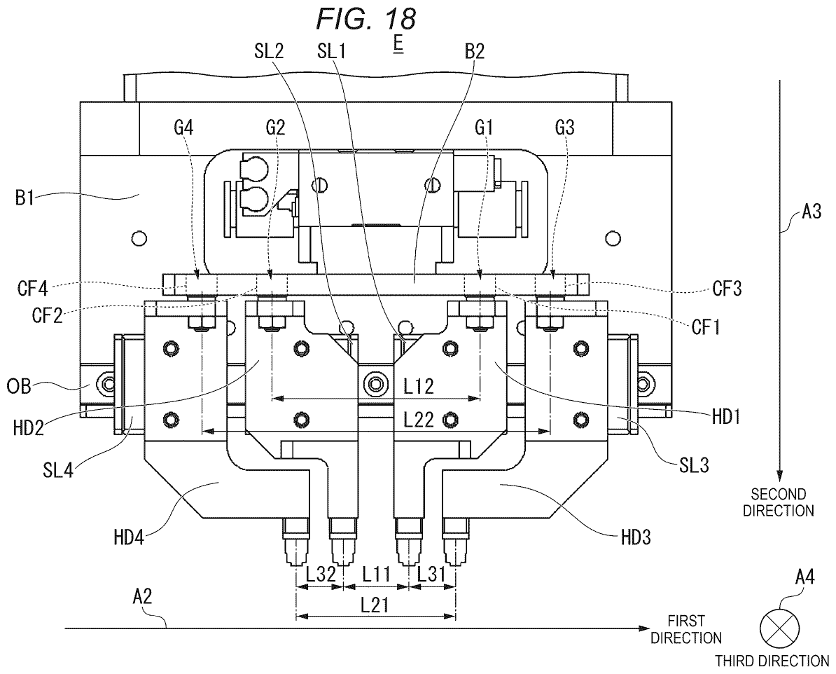

FIG. 16 is a perspective view showing an example of a configuration of the end effector E. FIG. 17 is a front view of the end effector E shown in FIG. 16. FIG. 18 is a bottom view of the end effector E shown in FIG. 16. In FIGS. 16 to 18, three directions orthogonal to one another, that is, a first direction, a second direction, and a third direction are respectively indicated by arrows. In FIGS. 16 to 18, the first direction is a direction indicated by an arrow A2. In FIGS. 16 to 18, the second direction is a direction indicated by an arrow A3. In FIGS. 16 to 18, the third direction is a direction indicated by an arrow A4. FIG. 17 shows the end effector E as seen in a direction opposite to the second direction. FIG. 18 shows the end effector E as seen in the third direction.

The end effector E includes an A-th base B1, a first holding portion HD1, a second holding portion HD2, a third holding portion HD3, a fourth holding portion HD4, a B-th base B2, and an A-th base movement unit MT.

The A-th base B1 is attached to the distal end of a manipulator. The A-th base B1 is a member provided with a first track OB, a first sliding portion SL1, a second sliding portion SL2, a third sliding portion SL3, and a fourth sliding portion SL4.

The first track OB is a member extending in a predetermined direction. In FIGS. 16 to 18, the first track OB extends in the first direction. The first track OB is, for example, a rail extending in the first direction, but may be another member extending in the first direction instead.

Each of the first sliding portion SL1, the second sliding portion SL2, the third sliding portion SL3, and the fourth sliding portion SL4 is a member slidably provided with respect to the first track OB. In the example shown in FIGS. 16 and 17, on the first track OB, the first sliding portion SL1, the second sliding portion SL2, the third sliding portion SL3, and the fourth sliding portion SL4 are arranged in the first direction in the order of the fourth sliding portion SL4, the second sliding portion SL2, the first sliding portion SL1, and the third sliding portion SL3.

The first sliding portion SL1 is provided with the first holding portion HD1 that holds the molded product M. That is, the first holding portion HD1 provided in the first sliding portion SL1 is movable in parallel to the first direction on the first track OB.

The second sliding portion SL2 is provided with the second holding portion HD2 that holds the molded product M. That is, the second holding portion HD2 provided in the second sliding portion SL2 is movable in parallel to the first direction on the first track OB.

The third sliding portion SL3 is provided with the third holding portion HD3 that holds the molded product M. That is, the third holding portion HD3 provided in the third sliding portion SL3 is movable in parallel to the first direction on the first track OB.

The fourth sliding portion SL4 is provided with the fourth holding portion HD4 that holds the molded product M. That is, the fourth holding portion HD4 provided in the fourth sliding portion SL4 is movable in parallel to the first direction on the first track OB.

The B-th base B2 is a flat plate-shaped member that supports each of the first holding portion HD1 to the fourth holding portion HD4 so that each of the first holding portion HD1 to the fourth holding portion HD4 projects in a predetermined direction.

In the example shown in FIGS. 16 to 18, the B-th base B2 supports each of the first holding portion HD1 to the fourth holding portion HD4 so that each of the first holding portion HD1 to the fourth holding portion HD4 projects in the second direction. In this case, the B-th base B2 is a flat plate-shaped member parallel to a virtual plane formed in the first direction and the third direction. Further, the B-th base B2 is provided on the A-th base B1 to be movable between a predetermined A-th position and a predetermined B-th position. The B-th base B2 is movable in parallel to the third direction, for example. The B-th base B2 may be configured to be movable in parallel to a virtual axis parallel to another direction. As below, as an example, a case where the A-th position is a position at a side in the third direction of the positions where the B-th base B2 can move with respect to the A-th base B1 will be described. Note that the A-th position may be another position of the positions where the B-th base B2 can move with respect to the A-th base B1 instead. Further, as below, as an example, a case where the B-th position is a position at an opposite side to the side in the third direction of the positions where the B-th base B2 can move with respect to the A-th base B1 will be described. Note that the B-th position may be another position of the positions where the B-th base B2 can move with respect to the A-th base B1 instead. The position of the B-th base B2 with respect to the A-th base B1 shown in FIGS. 16 to 18 is an example of the A-th position.

In the B-th base B2, with at least one of an end of the first holding portion HD1 at the B-th base B2 side and an end of the second holding portion HD2 at the B-th base B2 side as a cam follower, a groove for guiding the cam follower is formed. More specifically, in the B-th base B2, a groove for operating at least one of the first holding portion HD1 and the second holding portion HD2 as a cam is formed such that, when the relative position of the B-th base B2 to the A-th base B1 is the A-th position, an interval between the first holding portion HD1 and the second holding portion HD2 on the first track OB may be a first interval, and, when the relative position of the B-th base B2 to the A-th base B1 is the B-th position, the interval between the first holding portion HD1 and the second holding portion HD2 on the first track OB may be a second interval shorter than the first interval. As below, as an example, a case where a first groove G1 that guides the end of the first holding portion HD1 at the B-th base B2 side as a cam follower and a second groove G2 that guides the end of the second holding portion HD2 at the B-th base B2 side as a cam follower are formed in the B-th base B2 will be described. Hereinafter, for convenience of description, the end of the first holding portion HD1 at the B-th base B2 side is referred to as a first insertion part CF1. This is because the end is a part to be inserted into the first groove G1 as a cam follower. Further, hereinafter, for convenience of description, the end of the second holding portion HD2 at the B-th base B2 side is referred to as a second insertion part CF2. This is because the end is a part to be inserted into the second groove G2 as a cam follower.

The first groove G1 moves the first holding portion HD1 provided in the first sliding portion SL1 in parallel to the first direction by guiding the first insertion part CF1 according to the movement of the B-th base B2 between the A-th position and the B-th position. Further, the first groove G1 moves the first holding portion HD1 closer to the second holding portion HD2 according to the movement of the B-th base B2 from the A-th position to the B-th position. Furthermore, the first groove G1 moves the first holding portion HD1 away from the second holding portion HD2 according to the movement of the B-th base B2 from the B-th position to the A-th position.

The second groove G2 moves the second holding portion HD2 provided in the second sliding portion SL2 in parallel to the first direction by guiding the second insertion part CF2 according to the movement of the B-th base B2 between the A-th position and the B-th position. Further, the second groove G2 moves the second holding portion HD2 closer to the first holding portion HD1 according to the movement of the B-th base B2 from the A-th position to the B-th position. Furthermore, the second groove G2 moves the second holding portion HD2 away from the first holding portion HD1 according to the movement of the B-th base B2 from the B-th position to the A-th position.

Here, the shape of the first groove G1 as seen in a direction opposite to the second direction and the shape of the second groove G2 as seen in the direction opposite to the second direction are shapes plane-symmetrical to each other with respect to a virtual plane passing through a midpoint between the first insertion part CF1 and the second insertion part CF2 and being orthogonal to the first direction. The shape of the first groove G1 as seen in the direction opposite to the second direction and the shape of the second groove G2 as seen in the direction opposite to the second direction may be shapes not plane-symmetrical with respect to the plane.

In FIGS. 16 and 17, the two grooves of the first groove G1 and the second groove G2 are covered by other members and almost unseen.

The first holding portion HD1 is a member that holds the molded product M transferred from the arrangement mechanism 30. The first holding portion HD1 supported by the B-th base B2 extends in the second direction. A first tip portion BC1 that holds the molded product M is provided at a tip of the first holding portion HD1 at the side in the second direction. The first tip portion BC1 holds the molded product M by, for example, suction of air. The first tip portion BC1 may be configured to hold the molded product M using another method. The first tip portion BC1 is a member in which an air suction port is formed in parallel to the second direction. In the embodiment, the position of the first holding portion HD1 is represented by, for example, the position of the first tip portion BC1, but is not limited thereto.

The first holding portion HD1 is provided with a first position adjustment mechanism AJ1 that adjusts the relative position of the first tip portion BC1 to the first holding portion HD1. In the example shown in FIG. 17, the first position adjustment mechanism AJ1 is a pin inserted into an elongate hole formed in the first tip portion BC1. Here, the elongate hole is longer in the third direction. Accordingly, the first position adjustment mechanism AJ1 in this example is a mechanism that adjusts the relative position of the first tip portion BC1 to the first holding portion HD1 in the third direction. The first position adjustment mechanism AJ1 may be a mechanism that adjusts the relative position of the first tip portion BC1 to the first holding portion HD1 in one or more other directions. The first position adjustment mechanism AJ1 may have another configuration that can adjust the relative position of the first tip portion BC1 to the first holding portion HD1. Further, in the embodiment, the first holding portion HD1 is a member separate from the first tip portion BC1, but may be configured integrally with the first tip portion BC1 instead. In this case, the first holding portion HD1 may not include the first position adjustment mechanism AJ1.

The second holding portion HD2 is a member that holds the molded product M transferred from the arrangement mechanism 30. The second holding portion HD2 supported by the B-th base B2 extends in the second direction. A second tip portion BC2 that holds the molded product M is provided at a tip of the second holding portion HD2 at the side in the second direction. The second tip portion BC2 holds the molded product M by, for example, suction of air. The second tip portion BC2 may be configured to hold the molded product M using another method. The second tip portion BC2 is a member in which an air suction port is formed in parallel to the second direction. In the embodiment, the position of the second holding portion HD2 is represented by, for example, the position of the second tip portion BC2, but is not limited thereto.

The second holding portion HD2 is provided with a second position adjustment mechanism AJ2 for adjusting the relative position of the second tip portion BC2 to the second holding portion HD2. In the example shown in FIG. 17, the second position adjustment mechanism AJ2 is a pin inserted into an elongate hole formed in the second tip portion BC2. Here, the elongate hole is longer in the third direction. Accordingly, the second position adjustment mechanism AJ2 in this example is a mechanism that adjusts the relative position of the second tip portion BC2 to the second holding portion HD2 in the third direction. The second position adjustment mechanism AJ2 may be a mechanism that adjusts the relative position of the second tip portion BC2 to the second holding portion HD2 in one or more other directions. The second position adjustment mechanism AJ2 may have another configuration that can adjust the relative position of the second tip portion BC2 to the second holding portion HD2. In the embodiment, the second holding portion HD2 is a member separate from the second tip portion BC2, but may be configured integrally with the second tip portion BC2 instead. In this case, the second holding portion HD2 may not include the second position adjustment mechanism AJ2.

Here, the shape of the first holding portion HD1 and the shape of the second holding portion HD2 are shapes plane-symmetrical to each other with respect to a virtual plane passing through the midpoint between the first insertion part CF1 and the second insertion part CF2 and being orthogonal to the first direction. In the embodiment, the shape of the first holding portion HD1 and the shape of the second holding portion HD2 are crank shapes, but may be other shapes instead. Further, the shape of the first holding portion HD1 and the shape of the second holding portion HD2 may be shapes that are not plane-symmetrical to each other with respect to the plane.

As shown in FIG. 18, when the relative position of the B-th base B2 to the A-th base B1 is the A-th position, the interval between the first tip portion BC1 and the second tip portion BC2 is smaller than the interval between the first insertion part CF1 and the second insertion part CF2. The respective shapes of the first groove G1 and the second groove G2 as seen in the direction opposite to the second direction are determined as shapes in which the relationship between the widths of the two intervals is maintained even when the relative position of the B-th base B2 to the A-th base B1 is any position from the A-th position to the B-th position. Thereby, in the second robot 40, even when the intervals between the plurality of held molded products M are reduced, spaces can be left for the cam structures. Note that, in FIG. 18, the interval between the first tip portion BC1 and the second tip portion BC2 is indicated by an interval L11. Further, in FIG. 18, the interval between the first insertion part CF1 and the second insertion part CF2 is indicated by an interval L12.

In addition, in the B-th base B2, with at least one of an end of the third holding portion HD3 at the B-th base B2 side and an end of the fourth holding portion HD4 at the B-th base B2 side as a cam follower, a groove for guiding the cam follower is formed. More specifically, in the B-th base B2, a groove for operating at least one of the third holding portion HD3 and the fourth holding portion HD4 as a cam is formed such that, when the relative position of the B-th base B2 to the A-th base B1 is the A-th position, an interval between the third holding portion HD3 and the fourth holding portion HD4 on the first track OB is a third interval, and, when the relative position of the B-th base B2 with respect to the A-th base B1 is the B-th position, the interval between the third holding portion HD3 and the fourth holding portion HD4 on the first track OB is a fourth interval shorter than the first interval. As below, as an example, a case where a third groove G3 that guides the end of the third holding portion HD3 at the B-th base B2 side as a cam follower and a fourth groove G4 that guides the end of the fourth holding portion HD4 at the B-th base B2 side as a cam follower are formed in the B-th base B2 will be described. Hereinafter, for convenience of description, the end of the third holding portion HD3 at the B-th base B2 side is referred to as a third insertion part CF3. This is because the end is a part to be inserted into the third groove G3 as a cam follower. Further, hereinafter, for convenience of description, the end of the fourth holding portion HD4 at the B-th base B2 side is referred to as a fourth insertion part CF4. This is because the end is a part to be inserted into the fourth groove G4 as a cam follower.

The third groove G3 moves the third holding portion HD3 provided in the third sliding portion SL3 in parallel to the first direction by guiding the third insertion part CF3 according to the movement of the B-th base B2 between the A-th position and the B-th position. Further, the third groove G3 moves the third holding portion HD3 closer to the fourth holding portion HD4 according to the movement of the B-th base B2 from the A-th position to the B-th position. Furthermore, the third groove G3 moves the third holding portion HD3 away from the fourth holding portion HD4 according to the movement of the B-th base B2 from the B-th position to the A-th position.

The fourth groove G4 moves the fourth holding portion HD4 provided in the fourth sliding portion SL4 in parallel to the first direction by guiding the fourth insertion part CF4 according to the movement of the B-th base B2 between the A-th position and the B-th position. Further, the fourth groove G4 moves the fourth holding portion HD4 closer to the third holding portion HD3 according to the movement of the B-th base B2 from the A-th position to the B-th position. Furthermore, the fourth groove G4 moves the fourth holding portion HD4 away from the third holding portion HD3 according to the movement of the B-th base B2 from the B-th position to the A-th position.

Here, the shape of the third groove G3 as seen in the direction opposite to the second direction and the shape of the fourth groove G4 as seen in the direction opposite to the second direction are shapes plane-symmetrical to each other with respect to a virtual plane passing through a midpoint between the third insertion part CF3 and the fourth insertion part CF4 and being orthogonal to the first direction. The shape of the third groove G3 as seen in the direction opposite to the second direction and the shape of the fourth groove G4 as seen in the direction opposite to the second direction may be shapes not plane-symmetrical to each other with respect to the plane.

In FIGS. 16 and 17, the two grooves of the third groove G3 and the fourth groove G4 are covered by other members and almost unseen.

The third holding portion HD3 is a member that holds the molded product M transferred from the arrangement mechanism 30. The third holding portion HD3 supported by the B-th base B2 extends in the second direction. A third tip portion BC3 that holds the molded product M is provided at a tip of the third holding portion HD3 at the side in the second direction. The third tip portion BC3 holds the molded product M by, for example, suction of air. The third tip portion BC3 may be configured to hold the molded product M using another method. The third tip portion BC3 is a member in which an air suction port is formed in parallel to the second direction. In the embodiment, the position of the third holding portion HD3 is represented by, for example, the position of the third tip portion BC3, but is not limited thereto.

The third holding portion HD3 is provided with a third position adjustment mechanism AJ3 that adjusts the relative position of the third tip portion BC3 to the third holding portion HD3. In the example shown in FIG. 17, the third position adjustment mechanism AJ3 is a pin inserted into an elongate hole formed in the third tip portion BC3. Here, the elongate hole is longer in the third direction. Accordingly, the third position adjustment mechanism AJ3 in this example is a mechanism that adjusts the relative position of the third tip portion BC3 to the third holding portion HD3 in the third direction. The third position adjustment mechanism AJ3 may be a mechanism that adjusts the relative position of the third tip portion BC3 to the third holding portion HD3 in one or more other directions. The third position adjustment mechanism AJ3 may have another configuration that can adjust the relative position of the third tip portion BC3 to the third holding portion HD3. In the embodiment, the third holding portion HD3 is a member separate from the third tip portion BC3, but may be configured integrally with the third tip portion BC3 instead. In this case, the third holding portion HD3 may not include the third position adjustment mechanism AJ3.

The fourth holding portion HD4 is a member that holds the molded product M transferred from the arrangement mechanism 30. The fourth holding portion HD4 supported by the B-th base B2 extends in the second direction. A fourth tip portion BC4 that holds the molded product M is provided at a tip of the fourth holding portion HD4 at the side in the second direction. The fourth tip portion BC4 holds the molded product M by, for example, suction of air. The fourth tip portion BC4 may be configured to hold the molded product M using another method. The fourth tip portion BC4 is a member in which an air suction port is formed in parallel to the second direction. In the embodiment, the position of the fourth holding portion HD4 is represented by, for example, the position of the fourth tip portion BC4, but is not limited thereto.

The fourth holding portion HD4 is provided with a fourth position adjustment mechanism AJ4 for adjusting the relative position of the fourth tip portion BC4 to the fourth holding portion HD4. In the example shown in FIG. 17, the fourth position adjustment mechanism AJ4 is a pin inserted into an elongate hole formed in the fourth tip portion BC4. Here, the elongate hole is longer in the third direction. Accordingly, the fourth position adjustment mechanism AJ4 in this example is a mechanism that adjusts the relative position of the fourth tip portion BC4 to the fourth holding portion HD4 in the third direction. The fourth position adjustment mechanism AJ4 may be a mechanism that adjusts the relative position of the fourth tip portion BC4 to the fourth holding portion HD4 in one or more other directions. The fourth position adjustment mechanism AJ4 may have another configuration that can adjust the relative position of the fourth tip portion BC4 to the fourth holding portion HD4. In the embodiment, the fourth holding portion HD4 is a member separate from the fourth tip portion BC4, but may be configured integrally with the fourth tip portion BC4 instead. In this case, the fourth holding portion HD4 may not include the fourth position adjustment mechanism AJ4.

Here, the shape of the third holding portion HD3 and the shape of the fourth holding portion HD4 are shapes plane-symmetrical to each other with respect to a virtual plane passing through a midpoint between the third insertion part CF3 and the fourth insertion part CF4 and being orthogonal to the first direction. In the embodiment, the shape of the third holding part HD3 and the shape of the fourth holding part HD4 are crank shapes, but may be other shapes instead. In addition, the shape of the third holding part HD3 and the shape of the fourth holding part HD4 may be shapes not plane-symmetrical with respect to the plane.

As shown in FIG. 18, when the relative position of the B-th base B2 to the A-th base B1 is the A-th position, the interval between the third tip portion BC3 and the fourth tip portion BC4 is smaller than the interval between the third insertion part CF3 and the fourth insertion part CF4. The respective shapes of the third groove G3 and the fourth groove G4 as seen in the direction opposite to the second direction are determined as shapes in which the relationship between the widths of the two intervals is maintained even when the relative position of the B-th base B2 to the A-th base B1 is any position from the A-th position to the B-th position. Thereby, in the second robot 40, even when the intervals between the plurality of held molded products M are reduced, spaces can be left for the cam structures. In FIG. 18, the interval between the third tip portion BC3 and the fourth tip portion BC4 is indicated by an interval L21. In FIG. 18, the interval between the third insertion part CF3 and the fourth insertion part CF4 is indicated by an interval L22.

Further, an interval between the molded product M held by the first holding portion HD1 in a case where the relative position of the B-th base B2 to the A-th base B1 is the A-th position and the molded product M held by the third holding portion HD3 in this case is smaller than the above described interval L11. Furthermore, an interval between the molded product M held by the second holding portion HD2 in this case and the molded product M held by the fourth holding portion HD4 in this case is also smaller than the interval L11. An interval L32 is the same as an interval L31 except for differences due to manufacturing errors or the like. This is because the arrangement mechanism 30 changes the arrangement, and thereby, the second robot 40 holds the four molded products M arranged in one straight line of the eight molded products M arranged in the two-line arrangement using the end effector E. In FIG. 18, an interval between the molded product M held by the first holding portion HD1 in this case and the molded product M held by the third holding portion HD3 in this case is indicated by the interval L31. In FIG. 18, an interval between the molded product M held by the second holding portion HD2 in this case and the molded product M held by the fourth holding portion HD4 in this case is indicated by the interval L32.

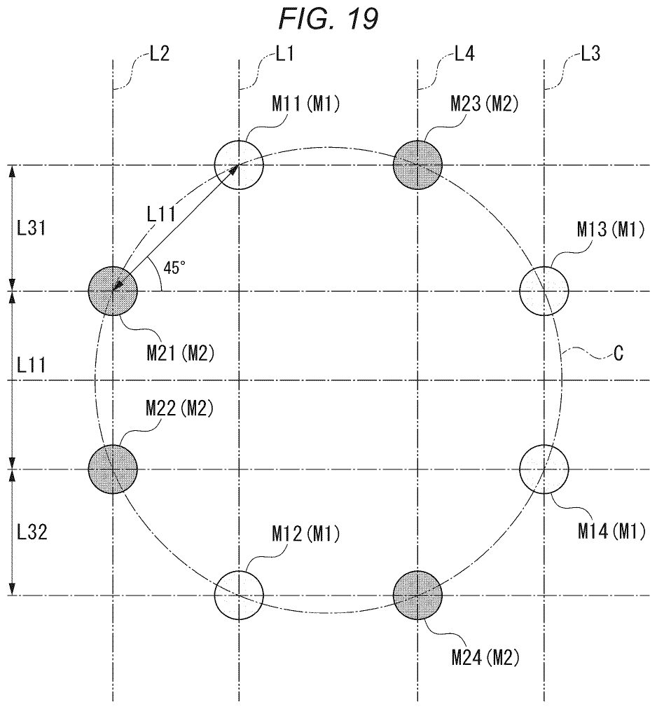

FIG. 19 is a diagram for explanation of a reason why the interval L31 and the interval L32 are smaller than the interval L11. FIG. 19 shows the eight molded products M arranged in the annular arrangement as the arrangement at molding on the arrangement mechanism 30. As shown in FIG. 19, in this case, as described in FIG. 6, these eight molded products M are arranged at equal intervals on the circumference C. Of the eight molded products M, the first molded product M11 and the first molded product M12 are located on the first straight line L1. Of the eight molded products M, the second molded product M21 and the second molded product M22 are located on the second straight line L2. Of the eight molded products M, the first molded product M13 and the first molded product M14 are located on the third straight line L3. Of the eight molded products M, the second molded product M23 and the second molded product M24 are located on the fourth straight line L4. As described above, in FIG. 19, these eight molded products M form a regular octagon.

Here, the above described interval L11 is determined to be equal to the interval between the second molded product M21 and the second molded product M22 when the eight molded products M are seen from the direction orthogonal to each of the first straight line L1 to the fourth straight line L4. Accordingly, in FIG. 19, the interval between the second molding product M21 and the second molding product M22 in this case is indicated as the interval L11. On the other hand, since the eight molded products M are arranged at equal intervals on the circumference C, the linear distance from the second molded product M21 to the first molded product M11 is equal to the interval L11 as shown in FIG. 19. An acute angle between a direction from the second molded product M21 toward the first molded product M11 and the direction orthogonal to each of the first straight line L1 to the fourth straight line L4 is 45°. Accordingly, it is understood that the interval between the second molded product M21 and the first molded product M11 when the eight molded products M are seen from the direction orthogonal to each of the first straight line L1 to the fourth straight line L4 is smaller than the interval L11 by calculation using a trigonometric function. When the arrangement at molding is changed to the changed arrangement by the arrangement mechanism 30, as described above, the first straight line L1 moves in the direction toward the second straight line L2 and finally overlaps with the second straight line L2. Therefore, the interval L31 becomes equal to the interval between the second molded product M21 and the first molded product M11 arranged on the second straight line L2. Further, the interval L31 is determined to be equal to the interval between the second molded product M21 and the first molded product M11 in this case. As described above, the interval L31 is smaller than the interval L11. The same applies to the interval L32. The fact that the interval L32 is the same as the interval L31 can be obtained by the same calculation.

With the end effector E, the second robot 40 palletizes the eight molded products M arranged in the two-line arrangement as the changed arrangement four by four at twice onto the pallet PT. That is, the second robot 40 palletizes the four molded products M arranged in the one-line arrangement of the eight molded products M arranged in the two-line arrangement onto the pallet PT, and then, palletizes the remaining four molded products M arranged in the one-line arrangement onto the pallet PT. The method of palletizing the molded products M onto the pallet PT by the second robot 40 may be a known method or a method to be developed. However, the second robot 40 changes the intervals between the four molded products M held by the end effector E before palletizing the four molded products M onto the palette PT. The second robot 40 moves the relative position of the B-th base B2 to the A-th base B1 of the end effector E from the A-th position to the B-th position, and thereby, reduces the intervals between the four molded products M.

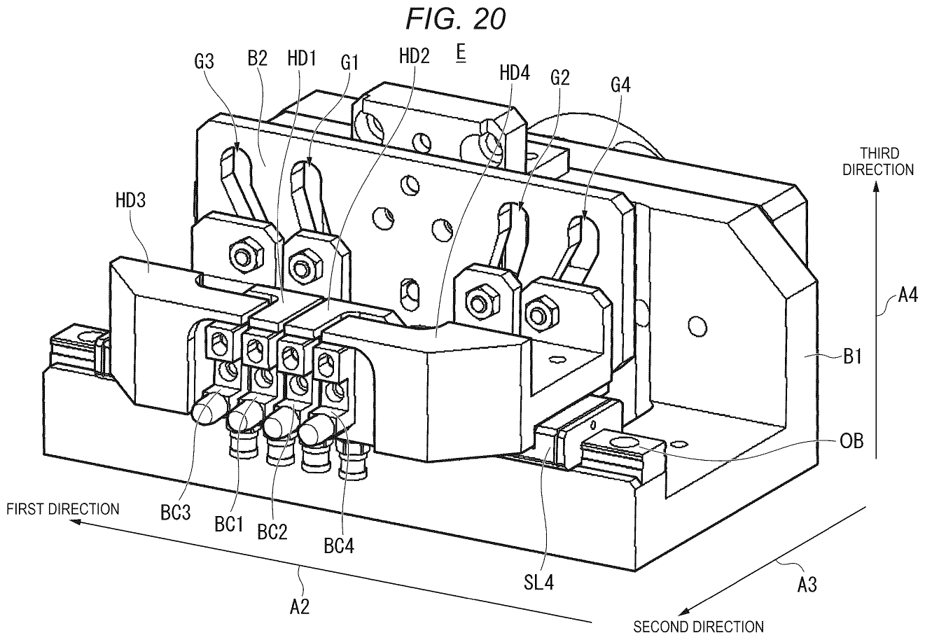

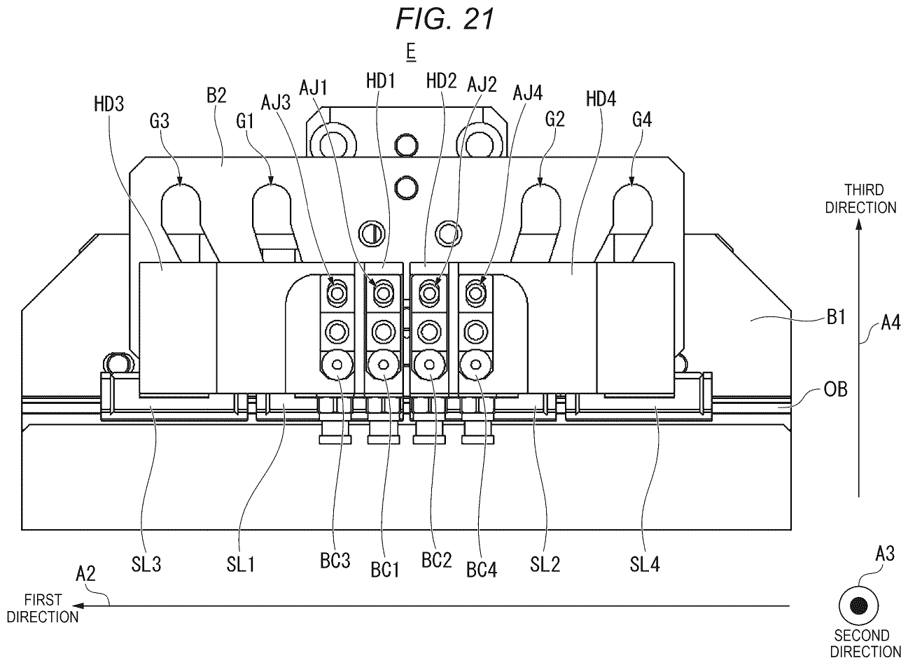

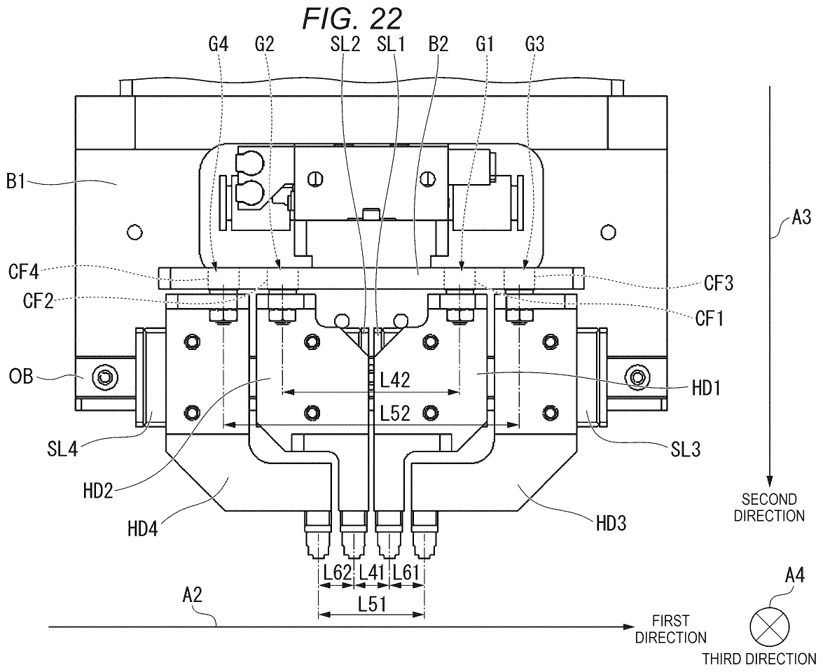

FIG. 20 is a perspective view of the end effector E when the relative position of the B-th base B2 to the A-th base B1 is the B-th position. FIG. 21 is a front view of the end effector E shown in FIG. 20. FIG. 22 is a bottom view of the end effector E shown in FIG. 20. Here, FIG. 21 shows the end effector E as seen in the direction opposite to the second direction. Further, FIG. 22 shows the end effector E as seen in the third direction.

As shown in FIGS. 20 to 22, the first holding portion HD1 and the second holding portion HD2 move in parallel to the first direction closer to each other according to the movement of the relative position of the B-th base B2 to the A-th base B1 from the A-th position to the B-th position. As a result, the interval between the first tip portion BC1 and the second tip portion BC2 becomes smaller from the interval L11 to the interval L41. Therefore, the interval between the molded product M held by the first holding portion HD1 and the molded product M held by the second holding portion HD2 becomes smaller according to the movement of the relative position of the B-th base B2 to the A-th base B1 from the A-th position to the B-th position.

Further, as shown in FIGS. 20 to 22, the third holding portion HD3 and the fourth holding portion HD4 move in parallel to the first direction closer to each other according to the movement of the relative position of the B-th base B2 to the A-th base B1 from the A-th position to the B-th position. As a result, the interval between the third tip portion BC3 and the fourth tip portion BC4 becomes smaller from the interval L21 to an interval L51. Therefore, the interval between the molded product M held by the third holding portion HD3 and the molded product M held by the fourth holding portion HD4 becomes smaller according to the movement of the relative position of the B-th base B2 to the A-th base B1 from the A-th position to the B-th position.

As described above, when the relative position of the B-th base B2 to the A-th base B1 is the B-th position, the interval L41 as the interval between the first tip portion BC1 and the second tip portion BC2 is also smaller than the interval L42 between the first insertion part CF1 and the second insertion part CF2.

As described above, when the relative position of the B-th base B2 with respect to the A-th base B1 is the B-th position, the interval L51 between the third tip portion BC3 and the fourth tip portion BC4 is smaller than an interval L52 between the third insertion part CF3 and the fourth insertion part CF4.

On the other hand, when the relative position of the B-th base B2 to the A-th base B1 is the B-th position, the interval between the first tip portion BC1 and the third tip portion BC3 is the same as the interval L41 except for differences due to manufacturing errors or the like. In this case, the interval between the second tip portion BC2 and the fourth tip portion BC4 is the same as the interval L41 except for differences due to manufacturing errors or the like. Here, in FIG. 22, the interval between the first tip portion BC1 and the third tip portion BC3 in this case is indicated by an interval L61. In FIG. 22, the interval between the second tip portion BC2 and the fourth tip portion BC4 in this case is indicated by an interval L62. The interval L41, the interval L61, and the interval L62 are equal to one another. This means that the four molded products M held by the end effector E in this case are held in a line at equal intervals. Therefore, the second robot 40 can palletize the four molded products M onto the pallet PT more densely.

The A-th base movement unit MT changes the relative position of the B-th base platform B2 to the A-th base B1 between the A-th position and the B-th position. The A-th base movement unit MT may have any configuration as long as the configuration can change the relative position of the B-th base platform B2 to the A-th base platform B1 between the A-th position and the B-th position.

The second robot 40 may include two or more end effectors E. In this case, the two or more end effectors E are provided in the manipulator of the second robot 40 such that the four molded products M held by the respective end effectors E are arranged in parallel. Thereby, the second robot 40 can increase the quantity of molded products M that can be placed on the pallet PT in single palletization, and can increase the quantity of molded products M to be placed on the pallet PT. As a result, the second robot 40 can shorten the cycle time of the manufacturing process of the molded products M.

Further, the interval change between the four molded products M by the second robot 40 may be performed in the arrangement mechanism 30. In this case, the arrangement mechanism 30 includes at least a part of the above described configuration of the second robot 40. In this case, the arrangement mechanism 30 includes a first placement portion on which the molded products M are placed instead of the first holding portion HD1, and includes a second placement portion on which the molded products M are placed instead of the second holding portion HD2. The interval change between the four molded products M by the second robot 40 may be performed in the first robot 20 with the arrangement change of the eight molded products M by the arrangement mechanism 30. In this case, the first robot 20 includes at least a part of the above described configuration of the arrangement mechanism 30 and at least a part of the above described configuration of the second robot 40.

The above described end effector E may further include an even number, two or more of holding portions to form a plane-symmetrical shape with respect to a virtual plane orthogonal to the first direction, in addition to the first holding portion HD1 to the fourth holding portion HD4.

The sintering device 50 is a device in which the pallet PT is stored with the second robot 40, and performs sintering of the molded products M by heating the molded products M, which are placed on the pallet PT by the second robot 40, together with the pallet PT. The sintering device 50 may have a configuration that includes a device that automatically performs storage of the pallet PT after palletization and supply of a new pallet PT, or may have a configuration in which the pallet PT may be replaced by a human hand.

According to the above described configuration, the injection molding machine 1 can change the arrangement of the plurality of molded products M with a simple structure. Further, the injection molding machine 1 can change the intervals between the plurality of molded products M with a simple structure.

The above described configurations may be combined in any manner.

### Appendix 1

[1]

An arrangement mechanism that changes an arrangement of three or more molded products, includes a first base on which two or more first molded products including an 11th molded product and a 12th molded product of the three or more molded products are placed, a second base on which one or more second molded products including a 21st molded product of the three or more molded products are placed, and a first base movement unit changing a relative position of the first base to the second base between a first position and a second position, wherein the 11th molded product and the 12th molded product placed on the first base are located on a virtual first straight line predetermined for the first base, the 21st molded product placed on the second base is located on a second straight line as a virtual straight line predetermined for the second base and being parallel to the first straight line, when the relative position is the first position, the first straight line and the second straight line do not overlap, and when the relative position is the second position, the first straight line and the second straight line overlap.

[2]

In the arrangement mechanism according to [1], when the relative position is the first position, the 11th molded product, the 12th molded product, and the 21st molded product are further located on a predetermined circumference, and when the relative position is the first position, distances between the adjacent two molded products of the three molded products of the 11th molded product, the 12th molded product, and the 21 st molded product are the same as one another.

[3]

In the arrangement mechanism according to [2], three or more of the first molded products including a 13th molded product of the three or more molded products and the 11th molded product and the 12th molded product are placed on the first base, three or more of the second molded products including a 22nd molded product and a 23rd molded product of the three or more molded products and the 21st molded product are placed on the second base, the 13th molded product placed on the first base is located on a third straight line as a virtual straight line predetermined for the first base and being parallel to the first straight line, the 22nd molded product and the 23rd molded product placed on the second base are located on a fourth straight line as a virtual straight line predetermined for the second base and being parallel to the second straight line, when the relative position is the first position, the 11th molded product, the 12th molded product, the 13th molded product, the 21st molded product, the 22nd molded product, and the 23rd molded product are further located on the circumference, when the relative position is the first position, the first straight line, the second straight line, the third straight line, and the fourth straight line are arranged in an order of the second straight line, the first straight line, the fourth straight line, and the third straight line in a direction from the second straight line toward the first straight line, when the relative position is the first position, a distance between the second straight line and the first straight line in the direction is the same as a distance between the fourth straight line and the third straight line in the direction, and when the relative position is the second position, the second straight line and the first straight line overlap and the fourth straight line and the third straight line overlap.

[4]

In the arrangement mechanism according to [3], when the relative position is the first position, distances between the adjacent two molded products of the six molded products of the 11th molded product, the 12th molded product, the 13th molded product, the 21st molded product, the 22nd molded product, and the 23rd molded product are the same as one another.

[5]

In the arrangement mechanism according to [2], four or more of the first molded products including a 13rd molded product and a 14th molded product of the three or more molded products and the 11th molded product and the 12th molded product are placed on the first base, four or more of the second molded products including a 22nd molded product, a 23rd molded product, and a 24th molded product of the three or more molded products and the 21th molded product are placed on the second base, the 13th molded product and the 14th molded product placed on the first base are located on a third straight line as a virtual straight line predetermined for the first base and being parallel to the first straight line, the 21st molded product and the 22nd molded product placed on the second base are located on the second straight line, the 23rd molded product and the 24th molded product placed on the second base are located on a fourth straight line as a virtual straight line predetermined for the second base and being parallel to the second straight line, when the relative position is the first position, the 11th molded product, the 12th molded product, the 13th molded product, the 14th molded product, the 21st molded product, the 22nd molded product, the 23rd molded product, and the 24th molded product are further located on the circumference, when the relative position is the first position, the first straight line, the second straight line, the third straight line, and the fourth straight line are arranged in an order of the second straight line, the first straight line, the fourth straight line, and the third straight line in a direction from the second straight line toward the first straight line, when the relative position is the first position, a distance between the second straight line and the first straight line in the direction is the same as a distance between the fourth straight line and the third straight line in the direction, and when the relative position is the second position, the second straight line and the first straight line overlap and the fourth straight line and the third straight line overlap.

[6]

In the arrangement mechanism according to [5], when the relative position is the first position, distances between the adjacent two molded products of the eight molded products of the 11th molded product, the 12th molded product, the 13th molded product, the 14th molded product, the 21st molded product, the 22nd molded product, the 23rd molded product, and the 24th molded product are the same as one another.

[7]

In the arrangement mechanism according to any one of [1] to [6], the first base movement unit changes the relative position between the first position and the second position by moving at least one of the first base and the second base in parallel to a direction orthogonal to each of the first straight line and the second straight line.

[8]

A robot that transports three or more molded products includes a first end effector holding two or more first molded products including an 11th molded product and a 12th molded product of the three or more molded products, a second end effector holding one or more second molded products including a 21st molded product of the three or more molded products, and an end effector movement unit changing a relative position of the first end effector to the second end effector between a first position and a second position, wherein the 11th molded product and the 12th molded product held by the first end effector are located on a virtual first straight line predetermined for the first end effector, the 21st molded product held by the second end effector is located on a second straight line as a virtual straight line predetermined for the second effector and being parallel to the first straight line, when the relative position is the first position, the first straight line and the second straight line do not overlap, and when the relative position is the second position, the first straight line and the second straight line overlap.

[9]

An injection molding machine includes the arrangement mechanism according to any one of [1] to [7], an injection molding mechanism molding the three or more molded products by injection molding, and a robot placing the two or more of the first molded products of the three or more molded products molded by the injection molding mechanism on the first base, and placing the one or more of the second molded products of the three or more molded products molded by the injection molding mechanism on the second base.

### Appendix 2

[1]

A robot includes an A-th base on which a first track extending in a predetermined first direction, a first sliding portion slidably provided with respect to the first track and a second sliding portion slidably provided with respect to the first track are provided, a first holding portion provided in the first sliding portion and holding a first molded product, a second holding portion provided in the second sliding portion and holding a second molded product, and a B-th base, wherein a groove for operating at least the first holding portion and the second portion as a cam is formed in the B-th base to set an interval between the first holding portion and the second holding portion on the first track to be a first interval when a relative position of the B-th base to the A-th base is an A-th position and the interval between the first holding portion and the second holding portion on the first track to be a second interval shorter than the first interval when the relative position of the B-th base to the A-th base is a B-th position.

[2]

The robot according to [1] includes an A-th base movement unit changing the relative position of the B-th base to the A-th base between the A-th position and the B-th position.

[3]

In the robot according to [1] or [2], a first groove for operating the first holding portion as a cam and a second groove for operating the second holding portion as a cam are formed as the groove for operating at least one of the first holding portion and the second holding portion in the B-th base.

[4]

In the robot according to [3], the first holding portion has a first tip portion provided at a tip of the first holding portion and holding the first molded product and a first insertion part inserted through the first groove, the second holding portion has a second tip portion provided at a tip of the second holding portion and holding the second molded product and a second insertion part inserted through the second groove, an interval between the first holding portion and the second holding portion on the first track is an interval between the first tip portion and the second tip portion, when the relative position of the B-th base to the A-th base is any position between the A-th position and the B-th position, the interval between the first tip portion and the second tip portion is smaller than an interval between the first insertion part and the second insertion part.

[5]

In the robot according to [4], a first position adjustment mechanism adjusting a relative position of the first tip portion to the first holding portion is provided in the first holding portion, and a second position adjustment mechanism adjusting a relative position of the second tip portion to the second holding portion is provided in the second holding portion.

[6]

In the robot according to [4] or [5], a shape of the first holding portion and a shape of the second holding portion are plane-symmetrical to each other with respect to a virtual plane passing through a midpoint of the first insertion part and the second insertion part and being orthogonal to the first direction.

[7]

In the robot according to any one of [1] to [6], the B-th base relatively moves to the A-th base in a direction orthogonal to the first direction.

[8]

The robot according to any one of [1] to [7] further includes a third holding portion holding a third molded product and a fourth holding portion holding a fourth molded product, wherein a third sliding portion slidably provided with respect to the first track and a fourth sliding portion slidably provided with respect to the first track are further provided on the A-th base, the first sliding portion, the second sliding portion, the third sliding portion, and the fourth sliding portion are arranged in an order of the third sliding portion, the first sliding portion, the second sliding portion, and the fourth sliding portion toward the first direction on the first track, the third holding portion is provided in the third sliding portion, the fourth holding portion is provided in the fourth sliding portion, a groove for operating at least one of the third holding portion and the fourth holding portion as a cam is formed in the B-th base to set an interval between the third holding portion and the fourth holding portion on the first track to be a third interval when the relative position of the B-th base to the A-th base is the A-th position and the interval between the third holding portion and the fourth holding portion on the first track to be a fourth interval shorter than the third interval when the relative position of the B-th base to the A-th base is the B-th position, and the third interval is longer than the first interval and the fourth interval is longer than the second interval.

[9]

In the robot according to [8], an interval between the first molded product held by the first holding portion when the relative position of the B-th base to the A-th base is the A-th position and the third molded product held by the third holding portion when the relative position of the B-th base to the A-th base is the A-th position is smaller than an interval between the first molded product held by the first holding portion when the relative position of the B-th base to the A-th base is the A-th position and the second molded product held by the second holding portion when the relative position of the B-th base to the A-th base is the A-th position, and the interval between the first molded product held by the first holding portion when the relative position of the B-th base to the A-th base is the B-th position and the third molded product held by the third holding portion when the relative position of the B-th base to the A-th base is the B-th position is the same as the interval between the first molded product held by the first holding portion when the relative position of the B-th base to the A-th base is the B-th position and the second molded product held by the second holding portion when the relative position of the B-th base to the A-th base is the B-th position.

[10]

The robot according to [8] or [9] further includes a C-th base on which a second track extending in the first direction and arranged in parallel to the first track, a fifth sliding portion slidably provided with respect to the second track, a sixth sliding portion slidably provided with respect to the second track, a seventh sliding portion slidably provided with respect to the second track, and an eighth sliding portion slidably provided with respect to the second track are provided, a fifth holding portion provided in the fifth sliding portion and holding a fifth molded product, a sixth holding portion provided in the sixth sliding portion and holding a sixth molded product, a seventh holding portion provided in the seventh sliding portion and holding a seventh molded product, an eighth holding portion provided in the eighth sliding portion and holding an eighth molded product, and a D-th base, a groove for operating at least one of the fifth holding portion and the sixth holding portion as a cam to set an interval between the fifth holding portion and the sixth holding portion on the second track to be a fifth interval when the relative position of the D-th base to the C-th base is a C-th position and the interval between the fifth holding portion and the sixth holding portion on the second track to be a sixth interval shorter than the fifth interval when the relative position of the D-th base to the C-th base is a D-th position and a groove for operating at least one of the seventh holding portion and the eighth holding portion as a cam to set an interval between the seventh holding portion and the eighth holding portion on the second track to be a seventh interval when the relative position of the D-th base to the C-th base is the C-th position and the interval between the seventh holding portion and the eighth holding portion on the second track to be an eighth interval shorter than the seventh interval when the relative position of the D-th base to the C-th base is the D-th position are formed in the D-th base, and the seventh interval is longer than the fifth interval and the eighth interval is longer than the sixth interval.

[11]

In the robot according to [10], an interval between the fifth molded product held by the fifth holding portion when the relative position of the D-th base to the C-th base is the C-th position and the seventh molded product held by the seventh holding portion when the relative position of the D-th base to the C-th base is the C-th position is smaller than an interval between the fifth molded product held by the fifth holding portion when the relative position of the D-th base to the C-th base is the C-th position and the sixth molded product held by the sixth holding portion when the relative position of the D-th base to the C-th base is the C-th position, and the interval between the fifth molded product held by the fifth holding portion when the relative position of the D-th base to the C-th base is the D-th position and the seventh molded product held by the seventh holding portion when the relative position of the D-th base to the C-th base is the D-th position is the same as the interval between the fifth molded product held by the fifth holding portion when the relative position of the D-th base to the C-th base is the D-th position and the sixth molded product held by the sixth holding portion when the relative position of the D-th base to the C-th base is the D-th position.

[12]

An arrangement mechanism includes an A-th base on which a first track extending in a predetermined first direction, a first sliding portion slidably provided with respect to the first track, and a second sliding portion slidably provided with respect to the first track are provided, a first placement portion provided in the first sliding portion, on which a first molded product is placed, a second placement portion provided in the second sliding portion, on which a second molded product is placed, and a B-th base, and a groove for operating at least the first placement portion and the second placement portion as a cam is formed in the B-th base to set an interval between the first placement portion and the second placement portion on the first track to be a first interval when a relative position of the B-th base to the A-th base is an A-th position and the interval between the first placement portion and the second placement portion on the first track to be a second interval shorter than the first interval when the relative position of the B-th base to the A-th base is a B-th position.

[13]

An injection molding machine includes the robot according to any one of [1] to and an injection molding mechanism molding two or more molded products including the first molded product and the second molded product by injection molding, wherein each of the first molded product and the second molded product of the two or more molded products molded by the injection molding mechanism is palletized by the robot.

Although the embodiments of the present disclosure are described in detail with reference to the drawings, the specific configurations are not limited to the embodiments and may be changed, replaced, deleted, or the like without departing from the gist of the present disclosure.

What is claimed is:

1. An arrangement mechanism that changes an arrangement of three or more molded products, comprising:
a first base on which two or more first molded products including an 11th molded product and a 12th molded product of the three or more molded products are placed;
a second base on which one or more second molded products including a 21st molded product of the three or more molded products are placed; and
a first base movement unit changing a relative position of the first base to the second base between a first position and a second position, wherein
the 11th molded product and the 12th molded product placed on the first base are located on a virtual first straight line predetermined for the first base,
the 21st molded product placed on the second base is located on a second straight line as a virtual straight line predetermined for the second base and being parallel to the first straight line,
when the relative position is the first position, the first straight line and the second straight line do not overlap, and
when the relative position is the second position, the first straight line and the second straight line overlap.

2. The arrangement mechanism according to claim 1, wherein
when the relative position is the first position, the 11th molded product, the 12th molded product, and the 21st molded product are further located on a predetermined circumference, and
when the relative position is the first position, distances between adjacent two molded products of the three molded products of the 11th molded product, the 12th molded product, and the 21st molded product are same as one another.

3. The arrangement mechanism according to claim 2, wherein
three or more of the first molded products including a 13th molded product of the three or more molded products and the 11th molded product and the 12th molded product are placed on the first base,
three or more of the second molded products including a 22nd molded product and a 23rd molded product of the three or more molded products and the 21st molded product are placed on the second base,
the 13th molded product placed on the first base is located on a third straight line as a virtual straight line predetermined for the first base and being parallel to the first straight line,
the 22nd molded product and the 23rd molded product placed on the second base are located on a fourth straight line as a virtual straight line predetermined for the second base and being parallel to the second straight line,
when the relative position is the first position, the 11th molded product, the 12th molded product, the 13th molded product, the 21st molded product, the 22nd molded product, and the 23rd molded product are further located on the circumference,
when the relative position is the first position, the first straight line, the second straight line, the third straight line, and the fourth straight line are arranged in an order of the second straight line, the first straight line, the fourth straight line, and the third straight line in a direction from the second straight line toward the first straight line,
when the relative position is the first position, a distance between the second straight line and the first straight line in the direction is same as a distance between the fourth straight line and the third straight line in the direction, and
when the relative position is the second position, the second straight line and the first straight line overlap and the fourth straight line and the third straight line overlap.

4. The arrangement mechanism according to claim 3, wherein
when the relative position is the first position, distances between adjacent two molded products of the six molded products of the 11th molded product, the 12th molded product, the 13th molded product, the 21st molded product, the 22nd molded product, and the 23rd molded product are the same as one another.

5. The arrangement mechanism according to claim 2, wherein
four or more of the first molded products including a 13th molded product and a 14th molded product of the three or more molded products and the 11th molded product and the 12th molded product are placed on the first base,
four or more of the second molded products including a 22nd molded product, a 23rd molded product, and a 24th molded product of the three or more molded products and the 21st molded product are placed on the second base,
the 13th molded product and the 14th molded product placed on the first base are located on a third straight line as a virtual straight line predetermined for the first base and being parallel to the first straight line,
the 21st molded product and the 22nd molded product placed on the second base are located on the second straight line,
the 23rd molded product and the 24th molded product placed on the second base are located on a fourth straight line as a virtual straight line predetermined for the second base and being parallel to the second straight line,
when the relative position is the first position, the 11th molded product, the 12th molded product, the 13th molded product, the 14th molded product, the 21st molded product, the 22nd molded product, the 23rd molded product, and the 24th molded product are further located on the circumference,
when the relative position is the first position, the first straight line, the second straight line, the third straight line, and the fourth straight line are arranged in an order of the second straight line, the first straight line, the fourth straight line, and the third straight line in a direction from the second straight line toward the first straight line,
when the relative position is the first position, a distance between the second straight line and the first straight line in the direction is same as a distance between the fourth straight line and the third straight line in the direction, and
when the relative position is the second position, the second straight line and the first straight line overlap and the fourth straight line and the third straight line overlap.

6. The arrangement mechanism according to claim 5, wherein
when the relative position is the first position, distances between adjacent two molded products of the eight molded products of the 11th molded product, the 12th molded product, the 13th molded product, the 14th molded product, the 21st molded product, the 22nd molded product, the 23rd molded product, and the 24th molded product are the same as one another.

7. The arrangement mechanism according to claim 1, wherein
the first base movement unit changes the relative position between the first position and the second position by moving at least one of the first base and the second base in parallel to a direction orthogonal to each of the first straight line and the second straight line.

8. A robot that transports three or more molded products, comprising:
a first end effector holding two or more first molded products including an 11th molded product and a 12th molded product of the three or more molded products;
a second end effector holding one or more second molded products including a 21 st molded product of the three or more molded products; and
an end effector movement unit changing a relative position of the first end effector to the second end effector between a first position and a second position, wherein
the 11th molded product and the 12th molded product held by the first end effector are located on a virtual first straight line predetermined for the first end effector,
the 21 st molded product held by the second end effector is located on a second straight line as a virtual straight line predetermined for the second effector and being parallel to the first straight line,
when the relative position is the first position, the first straight line and the second straight line do not overlap, and
when the relative position is the second position, the first straight line and the second straight line overlap.

9. An injection molding machine comprising:
the arrangement mechanism according to claim 1;
an injection molding mechanism molding the three or more molded products by injection molding; and
a robot placing the two or more of the first molded products of the three or more molded products molded by the injection molding mechanism on the first base, and placing the one or more of the second molded products of the three or more molded products molded by the injection molding mechanism on the second base.
